(19) United States
(12) Patent Application Publication
(10) Pub. No.: US 2009/0299793 A1
(43) Pub. Date: Dec. 3, 2009

(54) System and method for automating a business process of a service provider

(76) Inventor: Chet Guzel, Nanuet, NY (US)

Correspondence Address: SCULLY, SCOTT, MURPHY & PRESSER, P.C., 400 GARDEN CITY PLAZA, SUITE 300, GARDEN CITY, NY, 11530, US

(21) Appl. No.: 11/989,075

(22) PCT Filed: Jul. 21, 2006
(86) PCT No.: PCT/US2006/028492

§ 371 Date: Jul. 10, 2009

Related U.S. Application Data
(60) Provisional application No. 60/701,430, filed on Jul. 21, 2005.

(51) Int. Cl. G06Q 10/00; G06Q 30/00; G06Q 20/00; G06F 15/16; G06Q 50/00; G06Q 40/00

(52) U.S. Cl. 705/8; 705/7; 705/14.1; 705/34; 705/44; 709/206

(57) ABSTRACT

A method for automating performance of administrative tasks for a service provider is presented. The method includes storing information including customer profile data and account metadata, and organizing the stored information to facilitate automatic retrieval and manipulation of the information in order to perform a particular administrative task. The method further includes receiving at least one query from a user to initiate performance of a particular administrative task, and processing the organized information in response to the at least one query in conjunction with performing the particular administrative task.

### CROSS REFERENCE TO RELATED CASES

This claims priority to and the benefit of Provisional U.S. patent application Ser. No. 60/701,430, filed Jul. 21, 2005, the entirety of which is incorporated herein by reference.

### TECHNICAL FIELD

The invention relates generally to business management, customer support, and billing, and more particularly to automating business processes of a service provider.

### BACKGROUND INFORMATION

Service providers must manage their customers. Customer management typically involves keeping records regarding customer contact information, services provided to a customer, service plans enrolled in by the customer, customer billing information, and customer payment information, etc. Further, customer management involves various processes such as generating invoices, sending bills to customers, and collecting payment from customers. Moreover, customer agent, affiliate, and partner information must be managed and maintained.

Existing customer management systems do not provide an integrated suit of management functions that allow a service provider to manage customer, agent, partner, and affiliate information, and automatically execute processes involved with providing services to customers.

### SUMMARY OF THE INVENTION

In one aspect, the invention involves a method for automating performance of administrative tasks for a service provider that provides services for customers. The method includes storing information including profile data of each customer of the service provider and information including account metadata representing each customer's use of services provided by the service provider, organizing the stored information to facilitate automatic retrieval and manipulation of the information in order to perform a particular administrative task, receiving at least one query from a user to initiate performance of a particular administrative task, and processing the organized information in response to the at least one query in conjunction with performing the particular administrative task.

In one embodiment, the service provider provides a service including remote backing-up of data in a storage device, the metadata information including an amount of data space in the storage device utilized by the service provider in backing up data for a particular customer. The particular administrative task includes an automated billing transaction.

The method further includes retrieving the metadata information to obtain current use information regarding and amount of data backed-up by the service provider in a predetermined time interval for a particular customer, calculating a charge commensurate with an amount of data backed-up by the service provider in a predetermined time interval for a particular customer, and automatically generating an invoice including the charge.

The method further includes transmitting the calculated charge to a financial institution via a payment gateway to have the charge validated and upon receipt of a validation result, automatically generating the invoice. The method further includes automatically transmitting the invoice to the customer.

In another embodiment, the profile data of each customer of the service provider includes the customer's service plan. The charge calculating step includes assessing abase charge amount according to an amount of data storage space used in the time interval, determining a service plan level that the customer belongs to, and modifying the base charge according to one or more of any discounts or promotions to be applied commensurate with the service plan level.

In another embodiment, the profile data of each customer of the service provider and metadata representing that customer's use of services are stored in a first database associated with the service provider. The storing of the profile data and metadata includes importing the customer profile and metadata to a second database adapted to accept queries in conjunction with the performance of the particular administrative task.

In still another embodiment, the metadata in the first database is appended to a second database to form a complete and centralized database for customer data. In yet another embodiment, the method further includes the step of synchronizing the first database with the second database to update the second database. The method further includes providing an interface that enables a user to initiate performance of a particular administrative task In another embodiment, via the interface, the user initiates functionality adapted to perform customer management functions such as querying specific information about the customer and the customer's accounts with the service provider.

In still another embodiment, via the interface, the user initiates functionality adapted to perform customer billing management functions including one or more of: determining of service level plans, determining customers to be charged, determining processed invoices, check billing function; scheduling automatic performance of a particular business function.

In yet another embodiment, via the interface, the user initiates functionality adapted to perform partner management functions including one or more of: adding new partner associated with the service provider including corresponding contact information; adding agents associated with new or existing partners listing; and tracking payments to the partners.

In other embodiments, via the interface, the user initiates functionality adapted to perform agent management functions including one or more of: tracking relationship of an agent to the service provider; and tracking payments to agents of the partners.

In another embodiment, via the interface, the user initiates functionality adapted to perform independent affiliate management functions including: tracking relationship of an affiliate to the service provider; and tracking payments to affiliates.

In still another embodiment, the interface is provided via a web browser device, or a client device in communication with a server.

In another aspect, the invention involves a networked based system for automating performance of administrative tasks for businesses that provide remote data back-up services for customers. The system includes a means for storing information including profile data of each customer of the service provider and information including customer account metadata representing each customer's use of data storage space associated with back-up services performed by the service provider, a client device providing an interface for a user to generate at least one query to initiate performance of a particular administrative task, and a server means responsive to the at least one query for automatically retrieving customer profile data and customer account metadata from the storing means and processing the data and metadata in conjunction with the particular administrative task.

In one embodiment, the metadata includes an amount of data space in a storage device utilized by the service provider in backing up data for a particular customer.

In another embodiment, the particular administrative task includes automated billing transaction. The server means includes a means for calculating a charge commensurate with an amount of data backed-up by the service provider in a predetermined time interval for a particular customer, and a means for automatically generating an invoice including the charge.

In still another embodiment, the system further includes a payment gateway means for transmitting the calculated charge to a financial institution to have the calculated charge validated, and upon receipt of a validation result, automatically generating the invoice.

In another embodiment, the profile data of each customer of the service provider includes a customer's service plan. The means for calculating a charge includes a means for assessing a base charge amount according to an amount of data storage space used in the time interval, a means for determining a service plan level the customer belongs to, and a means for modifying the base charge according to one or more of: any discounts or promotions to be applied commensurate with the service plan level.

In still another embodiment, the system further includes a means for automatically transmitting the invoice to the customer.

In yet another embodiment, the means for storing information includes a first database associated with the service provider, and a second database adapted to accept queries in conjunction with the performance of the particular administrative task. The system further includes a means for importing the customer profile and metadata information from the first database to the second database.

In other embodiments, the system includes a means for appending the metadata in the first database to the second database to form a complete and centralized database for customer data.

In another embodiment, the system further includes a means for synchronizing the first database with the second database to update the second database, and a means for communicating the at least one query from the client device to the server means over a network connection.

In another embodiment, the at least one query is communicated to the server means over an Internet connection The client device includes a web-browser providing the interface.

In still another embodiment, the means for communicating comprises a TCP/IP based communications protocol.

In other embodiments, the server means includes a means for scheduling automatic performance of a particular business function.

In yet another embodiment, the server means includes an automated report generating means for extracting the customer profile and account metadata and generating reports at various levels of detail.

In yet another aspect, the invention involves a web-based system for performing business management functions for a provider of remote data back-up services. The system includes a client device providing an interface for a web user enabling generation of at least one query to initiate performance of a particular business function regarding a customer's account with the service provider, a data storage device for storing information including profile data of each customer of the service provider and information including account metadata representing that customer's use of storage space associated with back-up services performed by the service provider, a first server means for receiving the generated at least one query over an Internet connection, and enabling secure communication of the at least one query to a second server means, and the second server means adapted for accessing customer profile data and account metadata from the data storage device and processing the data in conjunction with a requested business management function, and securely downloading the requested data to the client device via the Internet connection.

These and other aspects, features, and advantages of the invention will become more apparent from the following drawings and description.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative block diagram of an automated business process system, according to one embodiment of the invention.

FIG. 2 is an illustrative flow diagram of steps for synchronizing a source database and an application database, according to one embodiment of the invention.

FIG. 3 is an illustrative block diagram of a request process, according to one embodiment of the invention.

FIG. 4 is an illustrative block diagram of various automated business processes, according to one embodiment of the invention.

FIG. 5 is an illustrative flow diagram of service level and pricing plan determination, according to one embodiment of the invention.

FIG. 6 is an illustrative block diagram of an automated business process system hierarchy, according to one embodiment of the invention. FIGS. 7A and 7B are illustrative block diagrams of a web-based account management system, according to one embodiment of the invention.

FIGS. 8A-8J are illustrative screen shots of a customer management console, according to one embodiment of the invention.

FIGS. 9A to 9E are illustrative screen shots of a customer billing management console, according to one embodiment of the invention.

FIGS. 10A-10J are illustrative screen shots of a partner management console, according to one embodiment of the invention.

FIGS. 11A-11D are illustrative screen shots of an agent management console, according to one embodiment of the invention.

FIG. 12 is an illustrative screen shot of an activity log monitor console, according to one embodiment of the invention.

FIGS. 13A to 13C are illustrative screen shots of a quick jobs console, according to one embodiment of the invention.

FIGS. 14A to 14K are illustrative screen shots of a server management console, according to one embodiment of the invention.

FIGS. 15A to 15C are illustrative screen shots of a user management console, according to one embodiment of the invention.

FIGS. 16A to 16B are illustrative screen shots of a service plans management console, according to one embodiment of the invention.

FIG. 17 is an illustrative screen shot of a SMTP settings console, according to one embodiment of the invention.

FIG. 18 is an illustrative screen shot of a template management console, according to one embodiment of the invention.

FIG. 19 is an illustrative screen shot of a transaction report console, according to one embodiment of the invention.

### DETAILED DESCRIPTION

The present invention is a business management, customer support, and billing application and system that automates a business process of a service provider.

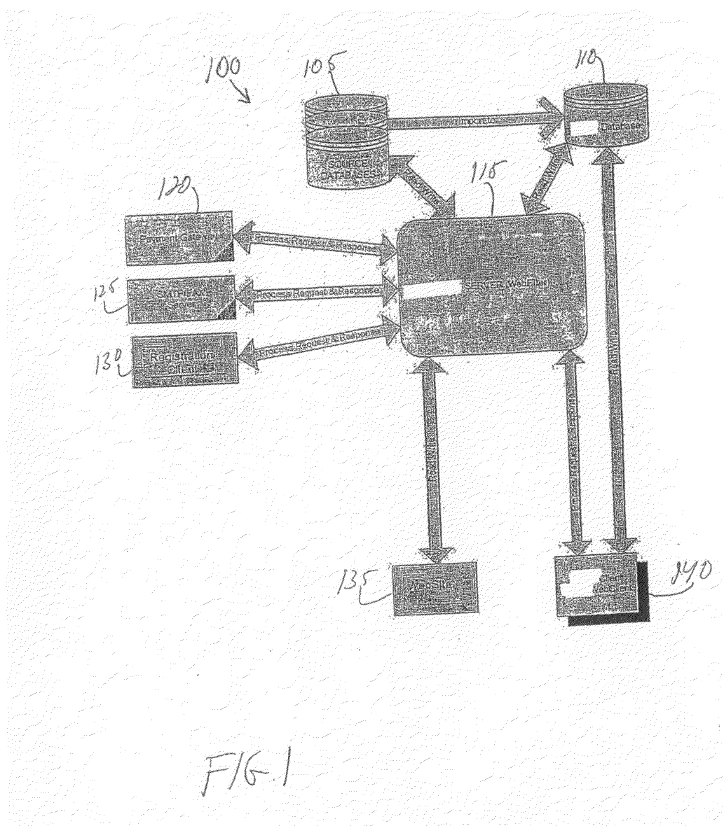

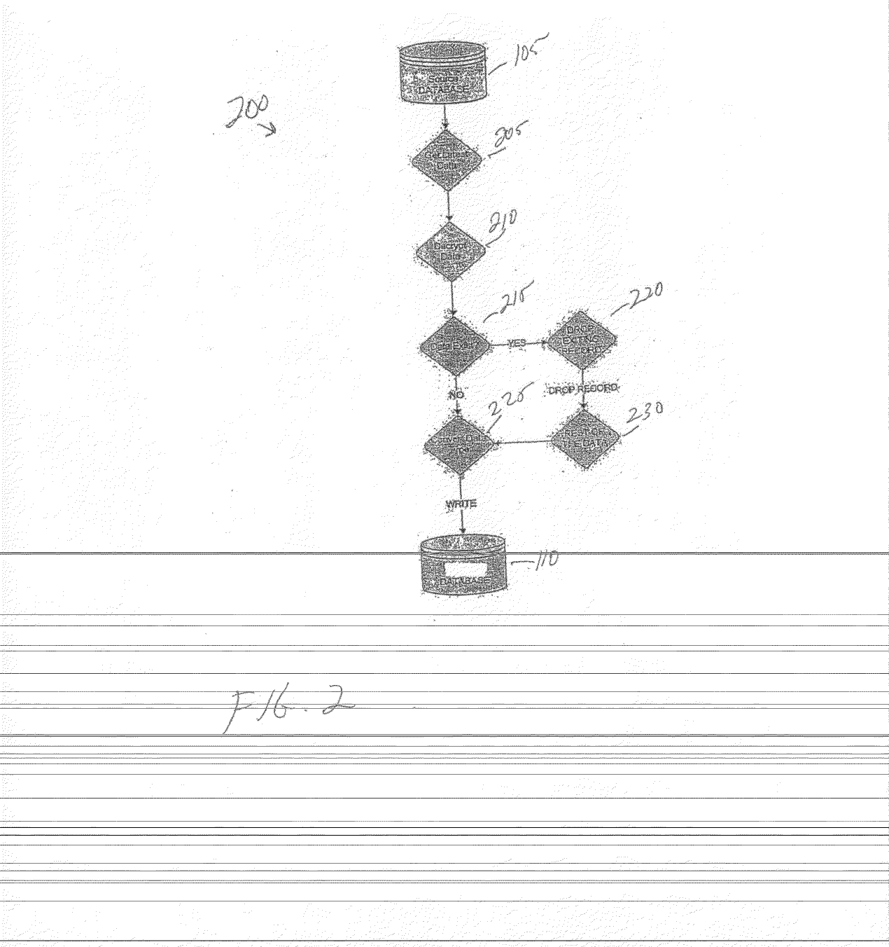

Referring to FIG. 1, in one embodiment, a block diagram of an automated business process system 100 is shown. The system 100 includes an application server 115, an application database 110, source or third party databases 105 (e.g., Access Database, MS SQL desktop version, MS SQL, MY SQL etc.), a payment gateway 120, an SMTP (email)/fax server 125, and a registration client 130. The application server 115 is in communication with a website 135 and an application client and/or a web client 140.

The invention also includes an application suite, which includes customer relationship management (CRM, customer support, sales force automation, marketing, accounting, third party accounting application export, and communication functions.

The application server 115 is capable of communicating with known databases. Some software providers, however, may use proprietary databases. In this case, the application server 115 either communicates directly with those databases or imports data from those databases to a known database, such as Access, SQL, for example, which the application server 115 uses as its native database.

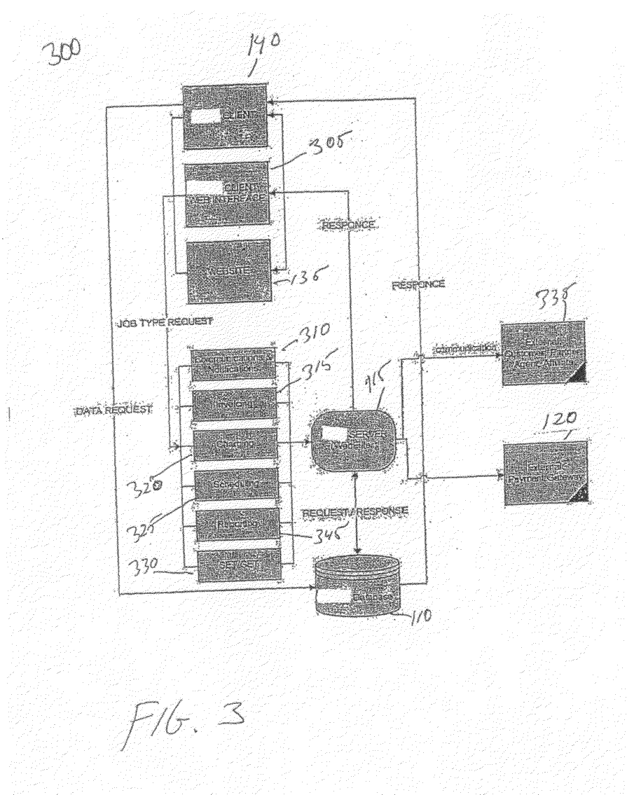

Referring to FIG. 2, in one embodiment, a flow diagram 200 of steps for synchronizing a source (third party) database 105 and an application database is shown. The application server 115 imports data from third party databases 105 (Step 205) and decrypts the data (if necessary) (Step 210). During the importing process, the application server 115 checks the application database 110 to determine if the imported data is not already in the application database 110 (Step 215). If the imported data already resides on the application database 110, the application server 115 discards the data (Step 220) and moves to the next record/data (Step 230). The application server 115 matches or converts the data type from third party database 105 to the data type of the application database 110 (Step 235). In one embodiment, the application server 115 examines the data from the third party database 105 and reformats the to an international data format and then writes the data to the application database 110. In another embodiment, the application server 115 converts the third party data into string data and then stores the data as a string in the application database 110. The application server 115 also uses a filter to clean up the data from the third party database 105. This process continues until the desired data is completely imported from the third party database 105 to the application database 110.

Once data importing is completed, the application server 115 regularly synchronizes the application database 110 with the third party database 105. If new data added to the third party database 105, then the application server 115 imports that new data into the application database 110.

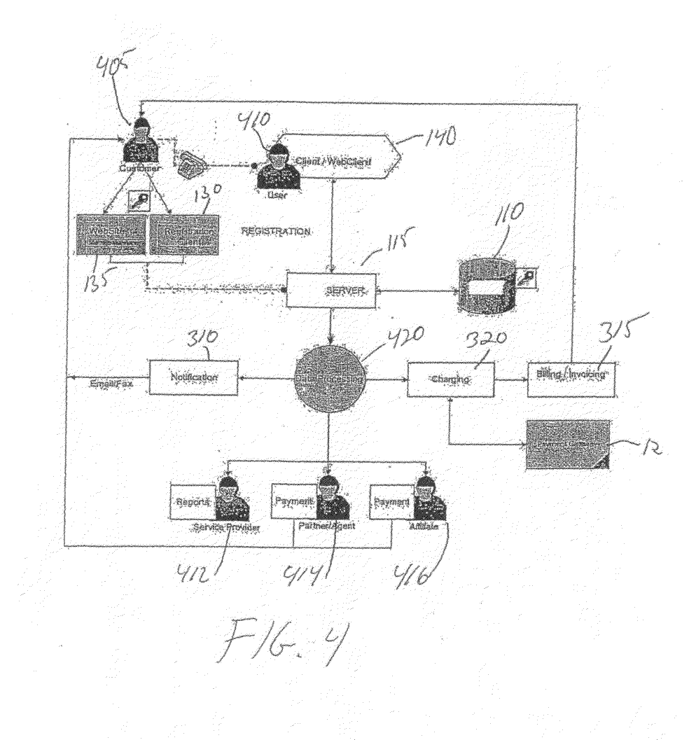

Referring to FIG. 3, in one embodiment, a block diagram of a request process 300 is shown. The application server 114 is continuously listening for requests related to user, customer, partner, agent, affiliate, and system and set business functions via various interfaces, such as the application client 140, an application client web interface 305, and the web site 135. When the application server 115 receives a request from one or more of the interfaces, the application server 115 executes various processes and transmits responses back to the one or more interfaces so the results can be printed to a computer screen or printer. If the one or more interfaces request communication (e.g., a fax or email), then the application server 115 executes and completes the appropriate process creating a fax (or email) and forwards the fax to the SMTP/fax server 125. The SMTP/fax server 125 then forwards the fax to the requested destination 335. Fax (or email) content can include invoice correspondence 315, event alert 345, notifications 310, etc.

After the application server 115 creates an invoice, the application server 115 forwards the invoice to an email/a fax server 125, which then sends the email/fax to the desired destination.

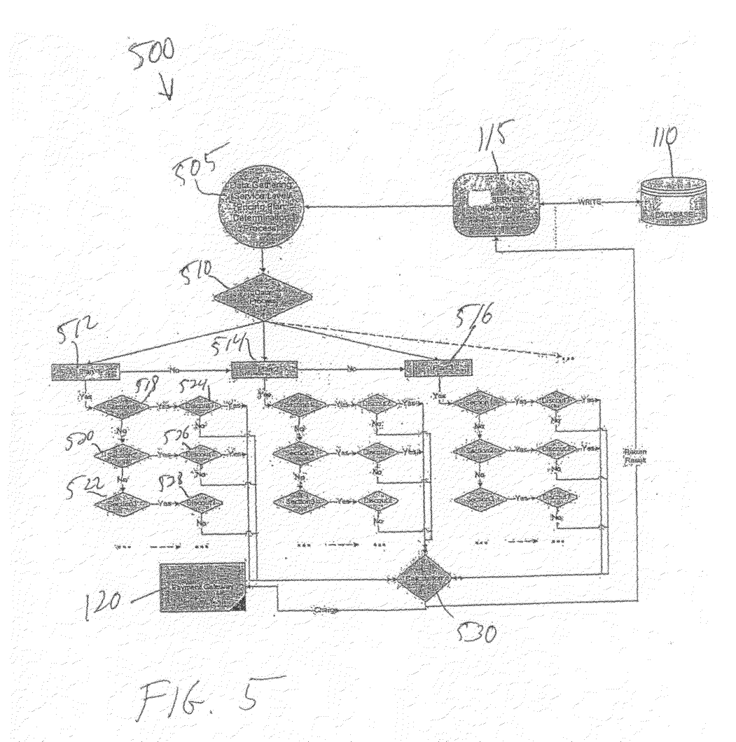

Referring to FIG. 4, in one embodiment, a block diagram of various automated business processes is shown. According to the block diagram, a customer can access the application server 115 via the website 135. A new customer can also register with the application sever 115 via the registration server 130. A user 410 can access the application server 115 via the client/web client 140. The user 410 can request various processes from the application server 115 that are processed by a data processing portion 420 of the application server 115. The various processes include, but are not limited to, a notification 310 be sent to the customer 405, a charge 320 and/or invoice 315 be sent to the customer 405, or a payment be made to a service provider 412, partner/agent 414, and or an affiliate 416.

If a user, through one or more of the interfaces, requests a charge be made to a customer (via a charging module 320), or the application server 115 needs to charge customers, then the application server 115 calculates what a customer should pay, then contacts the payment gateway 120 and submits the charges/authorizations then waits for result response from the gateway 120. According to the response, the application server 115 prepares invoices and specific text that is included on the invoice (such as: your account is charged, your payment is denied, your card will expire in such date, etc.).

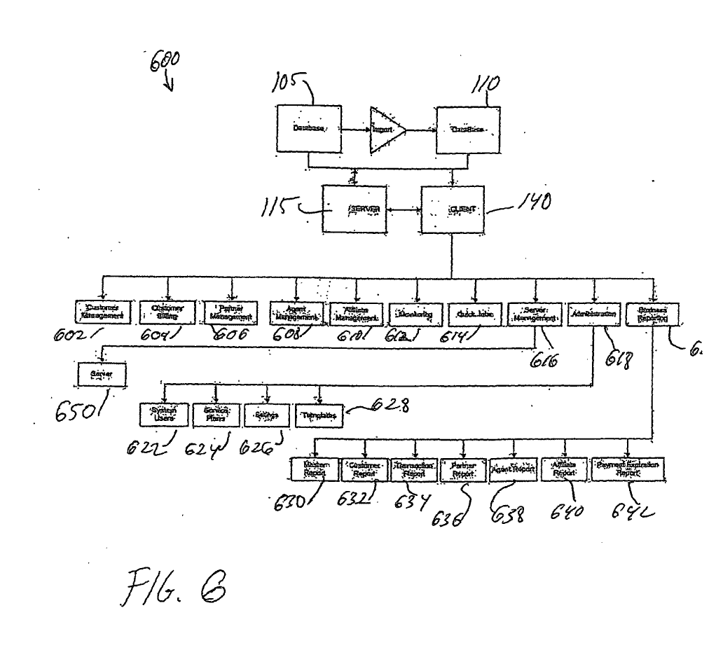

Referring to FIG. 5, in one embodiment, a flow diagram of service level and pricing plan determination is shown. The application server 115 calculates charges to a customer by gathering information regarding the customer's service level and pricing plan 505. The application server 115 processes this gathered information 510. After the application server 115 determines which pricing plan 512, 514, 516 the customer has selected, the application server 115 then determines which additional services 518, 520, 522, and discounts 524, 526, 528 the customer has.

The application server 115 also examines the customer's selected service level and any additional services the customer has selected or enrolled in and compares this data with the service plan previously selected by the customer. The resources that the application server 115 will use are then determined. These results are written to the application database 110 and the appropriate charges are calculated 530 communicated to the customer via the payment gateway 120.

The application server 115 also listens for requests for third party registration applications. A third party can send a registration request to the application server 115 via the registration client 130. The application server 115 receives the third party registration information from the registration client 130 and registers the new customer (third party) in the application database 110. The application server 115, pursuant to a customer's request (via the application client web interface 305), can also build a custom backup client with backup set 330, backup schedule 325, and the customer's username and password. The customer would log on to the application server 115 via the website 135 and schedule a backup day and time. Then the customer clicks a button to build the back up client. The application server 115 records the user's username, password, backup schedule details, and the customer's computer system configuration and settings. The application server 115 then adds the backup job into an installable set of setup files. The user is then directed to download a backup client and install it on his/her computer. Once the installation is complete, the user selects which files to backup. No further configuration is necessary.

The application server 115 automatically determines the particular service plan a particular customer is using based on customer preferences, customer selected level of service, and/or the amount of customer data to be backed up. Customer charges are calculated based on the customer's particular service plan.

The application server 115 includes a web filter that handles and filters requests from and responses to the application client 140, an application client web interface 305, and the web site 135.

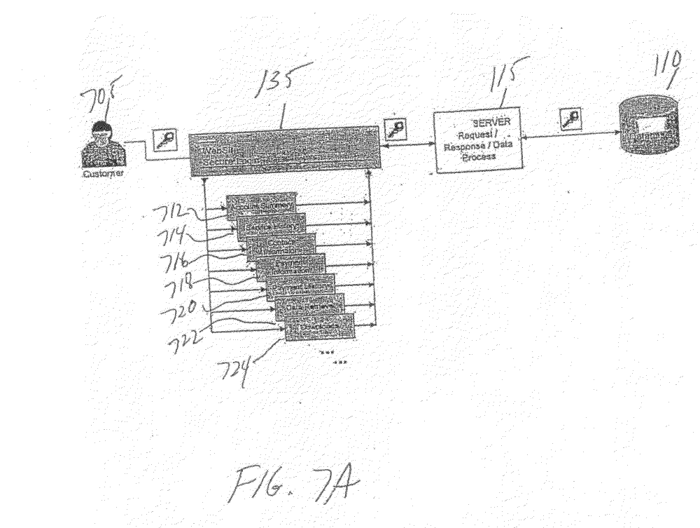

Referring to FIG. 6, in one embodiment, illustrative block diagram of an automated business process system hierarchy is shown. The application client includes software that allows a user to perform various functions. The software includes various modules including: a customer management module 602, a customer billing module 604, a partner management module 606, an agent management module 608, and affiliate management module 610, a monitoring module 612, a quick jobs module 614, a server management module 616, an administration module 618, and a business reporting module 620. The server management module 616 is used to manage additional servers (e.g., server 650). The administration module 618 include a system users module 622, a service plans module 624, a settings module 626, and a templates module 628. The business reporting module 620 includes a master report module 630, a customer report module 632, a transaction report module 634, a partner report module 636, and agent report module 638, an affiliate report module 640, and a payment report module 642. Each module is discussed in detail below.

Referring to FIGS. 7A and 7B, in one embodiment, block diagrams of a web-based account management system are shown. The web site 135 can interact with application server 115 similar to the way the application client 140 does. For example, a customer 705, via the web site 135, can create custom installation kit, create a new customer account, create an agent account, and create affiliate accounts. The web site 135 enables a customer to mange their account, print reports, update information, set properties. The web site 135 also allows the customer 705 to review their account summary 712, review their service history 714, review their contact information 716, review their payment information 718, review their payment history 720, retrieve data 722, and initiate downloads 724.

Similarly, a partner 730, an agent 740, and/or an affiliate 750 can access the application server 115 and application database 110 via the web site 135 to perform functions such as review a customer list 752, add a new customer 754, review contact information 756, review account information 758, track payment 760, and initiate business promotions 762.

The application server 115 can also post information to the web site 135 so customers, partners, affiliates, and agents can manage their respective accounts via the web site 135.

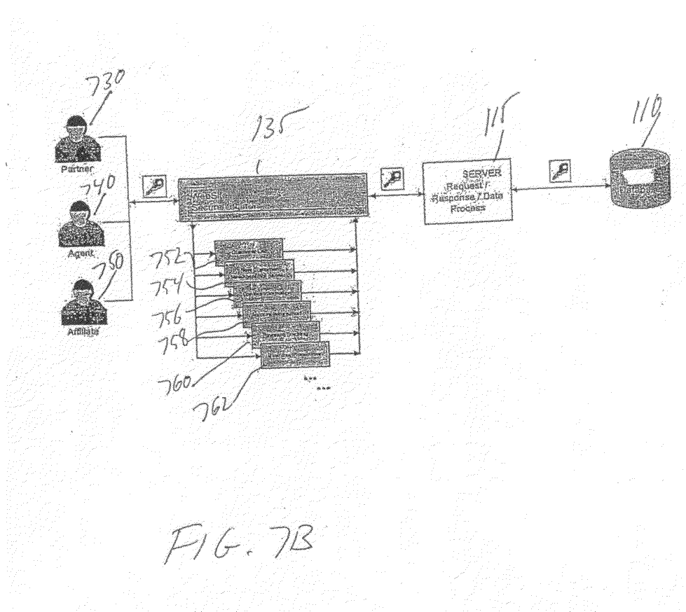

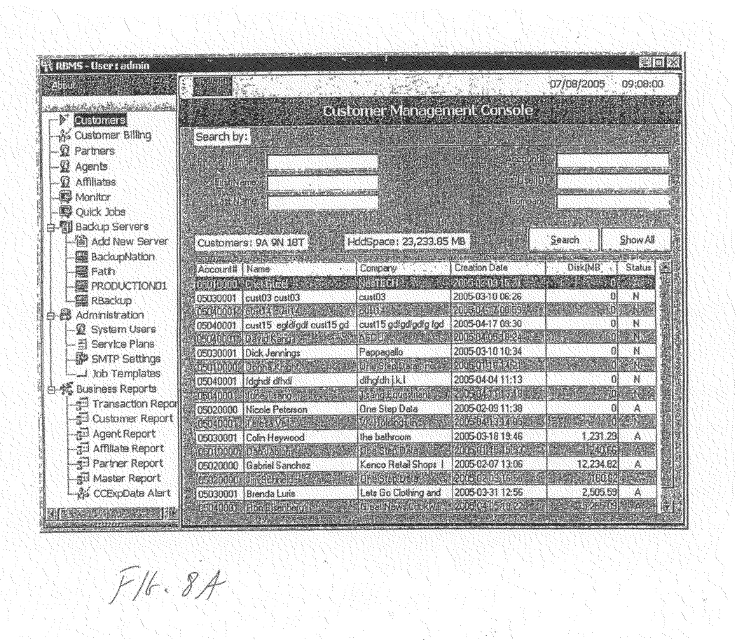

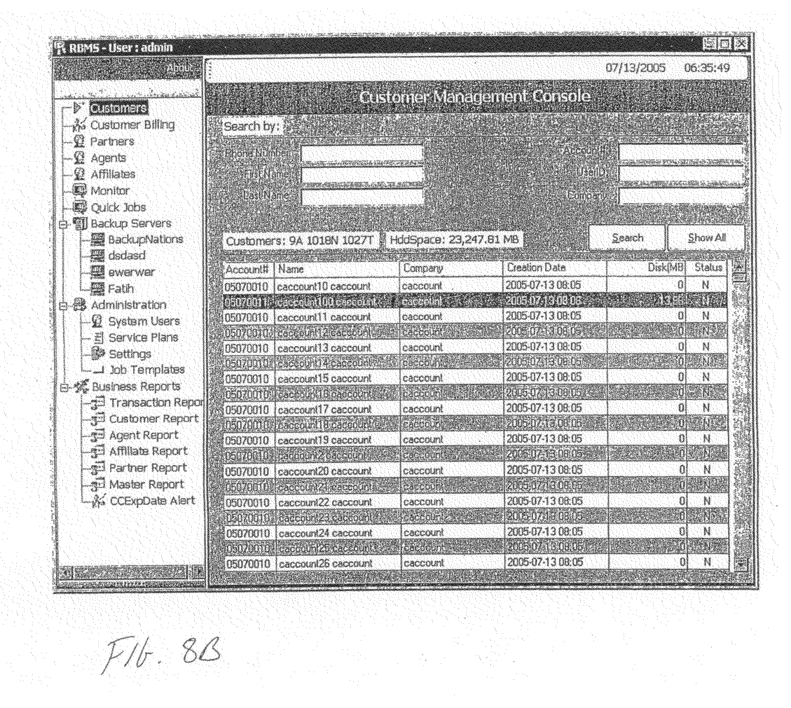

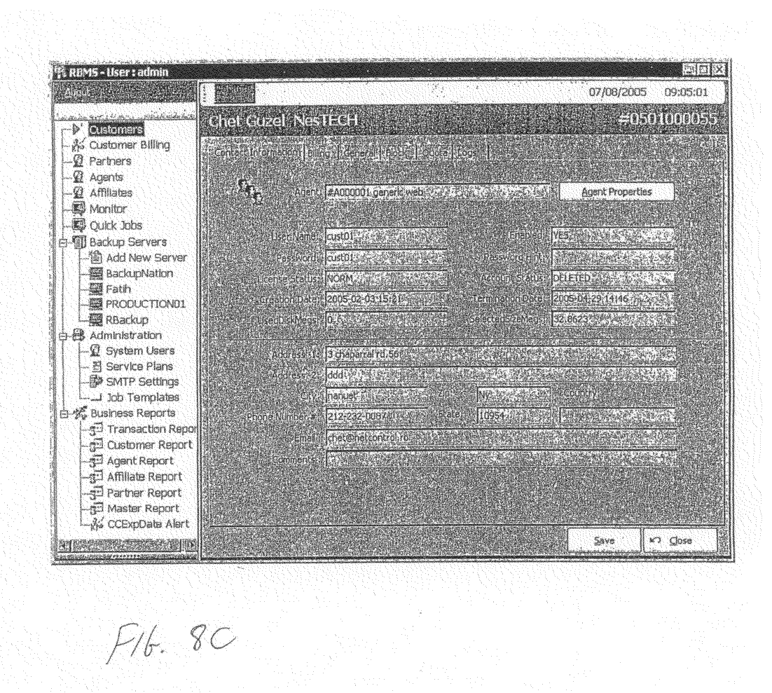

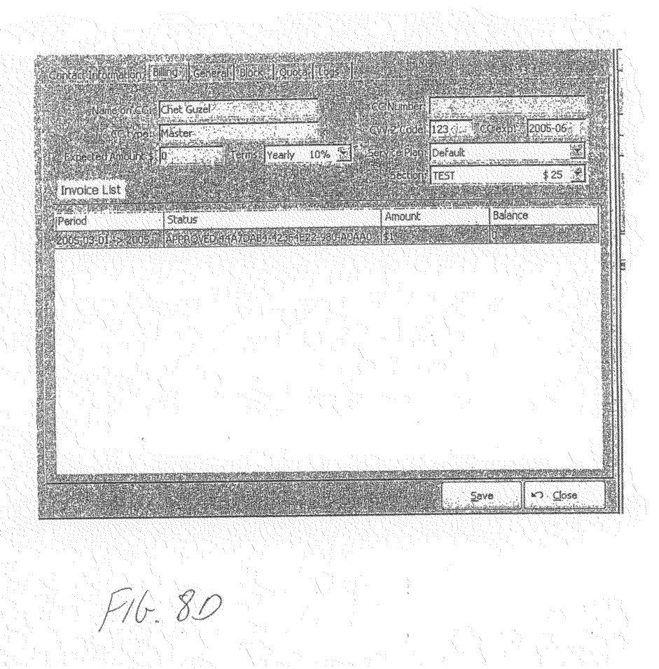

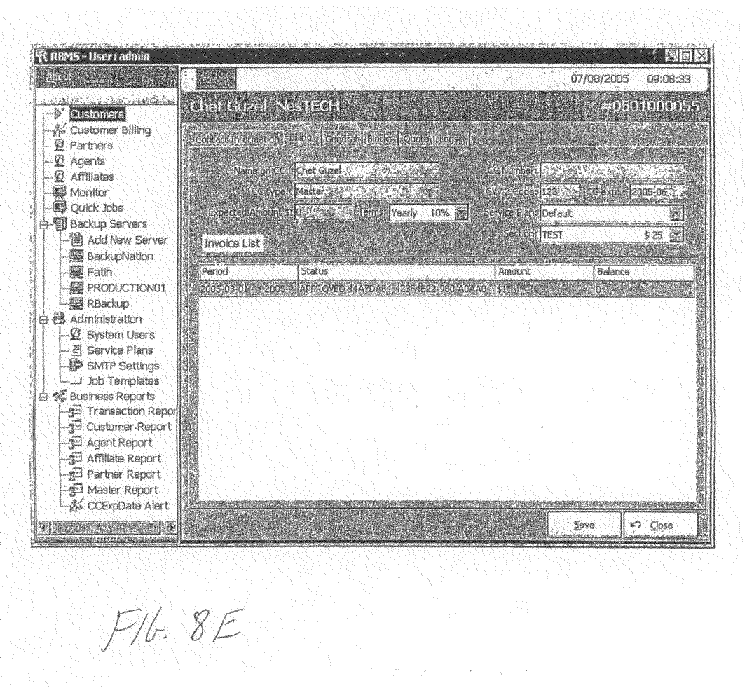

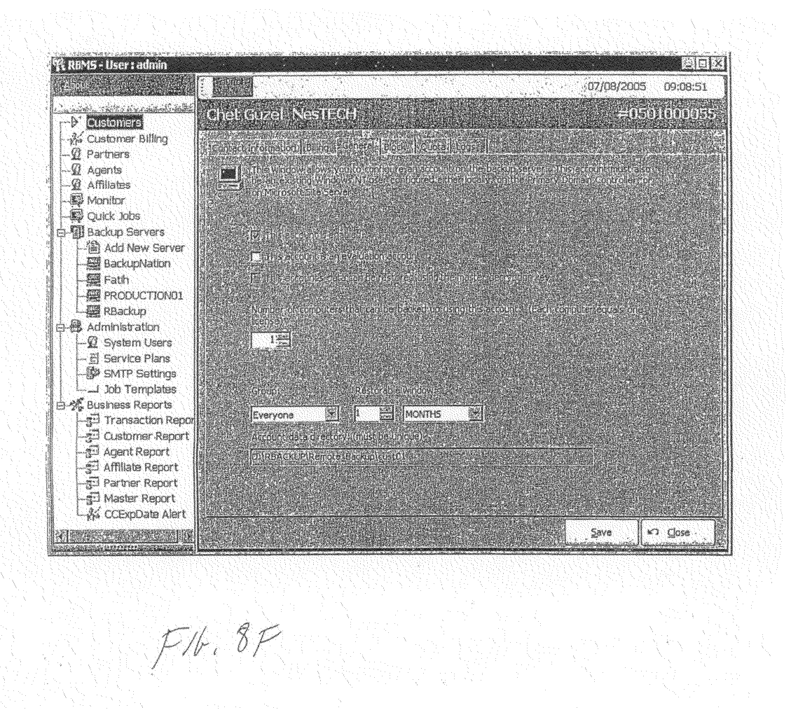

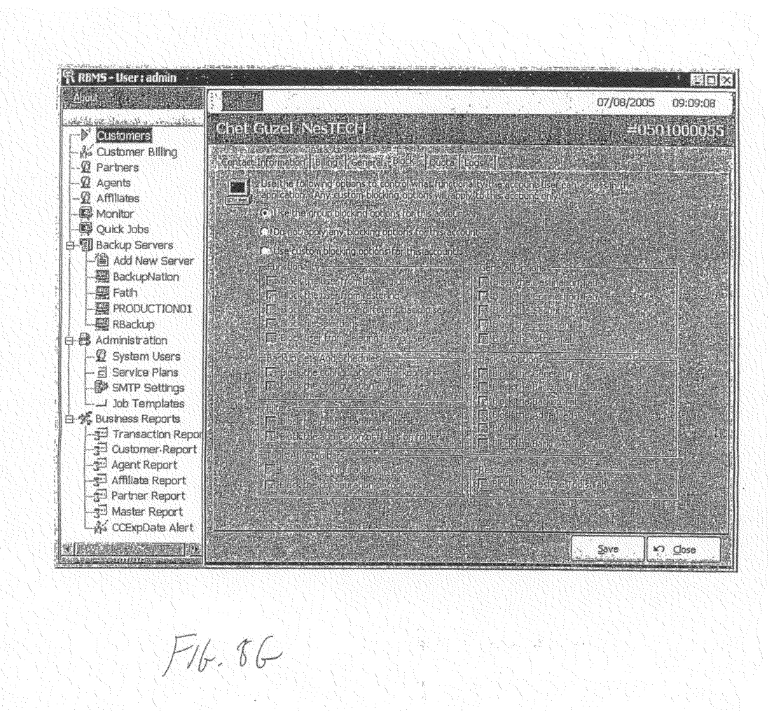

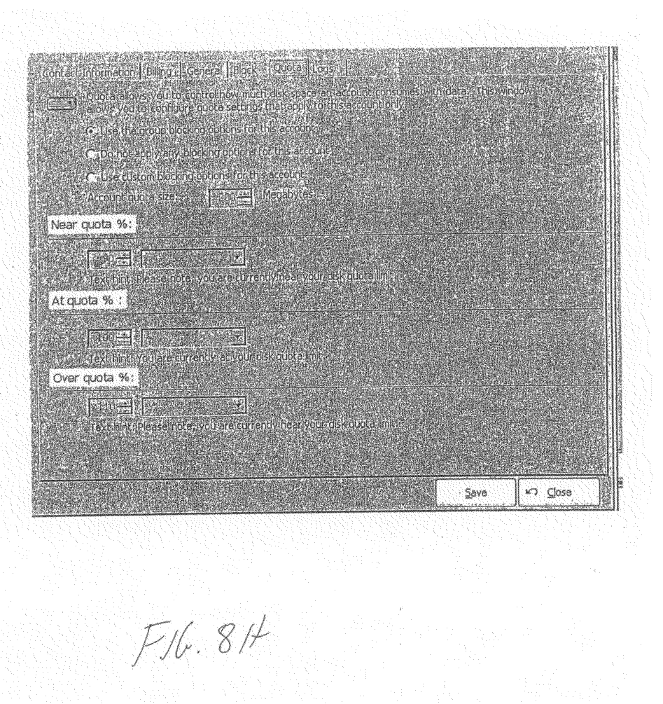

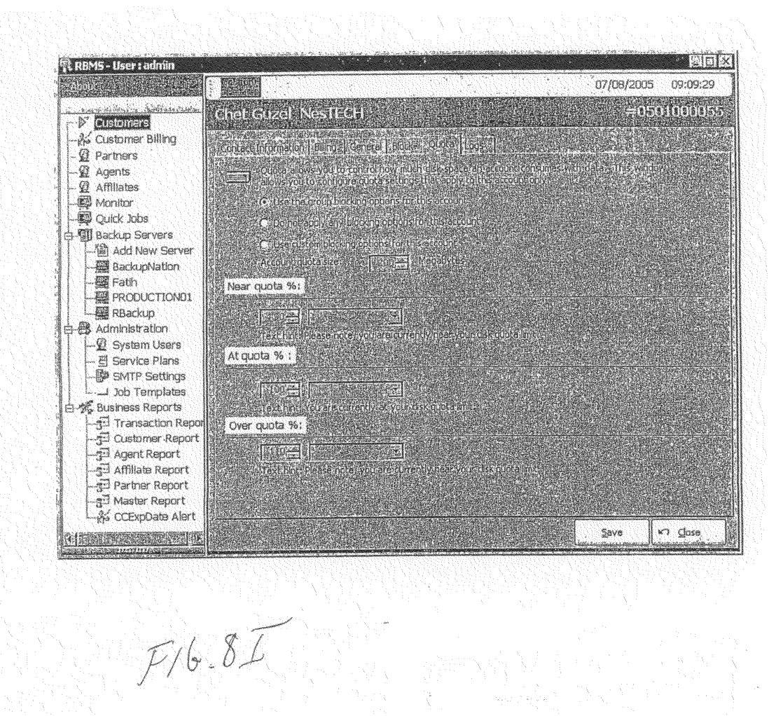

Referring to FIGS. 8A to 8J, screen shots of a customer management console are shown The customer management console resides and executes on the application client 140. The customer management console enables a service provider to provide customer support and management functions. As shown in the screen shots, customers are listed in a manageable and sortable list. A user is able to search for a customer by phone number, first name, last name, account number, User ID, company name, etc. The user can also print a customer's detailed profile (customer properties) by right clicking (with a mouse, for example) the menu or double clicking on the customer name. The customer management console is able to read from and write to multiple databases (MS mdb, SQL etc.) if desired. The customer management console is also configured to print (to a screen or printer) information such as customer count organized by customer total, activated account, not activated account, total space used by a customer on the storage servers. Various fields can be selected from the “view menu”. These fields are also sortable.

The customer property allows user to see the account and customer details in a tabbed form. The contact information tab, when selected, allows the user to display, set, or change customer and account details. This information includes any customer connections to an agent, or affiliate that referred. Clicking the “Agent Properties” button will display the agent property page, which is discussed below. The billing tab, when selected, allows the user to display, set, or change billing method information, billing information, discount information, and the service plan for the customer. The general tab, when selected, allows the user to display, set, or change user account status, customer's file location, restore window, etc. The block tab, when selected, allows the user to display, set, or change customer account policy. The quote tab, when selected, allows the user to display, set, or change customer account limitations. The logs tab, when selected, allows the user to display a customer's activity logs.

All processes are written to the application database 110. Everything that is generated by the application server 115 or application client 140 is written to the application database 100 for the purpose of keeping history logs and/or data history.

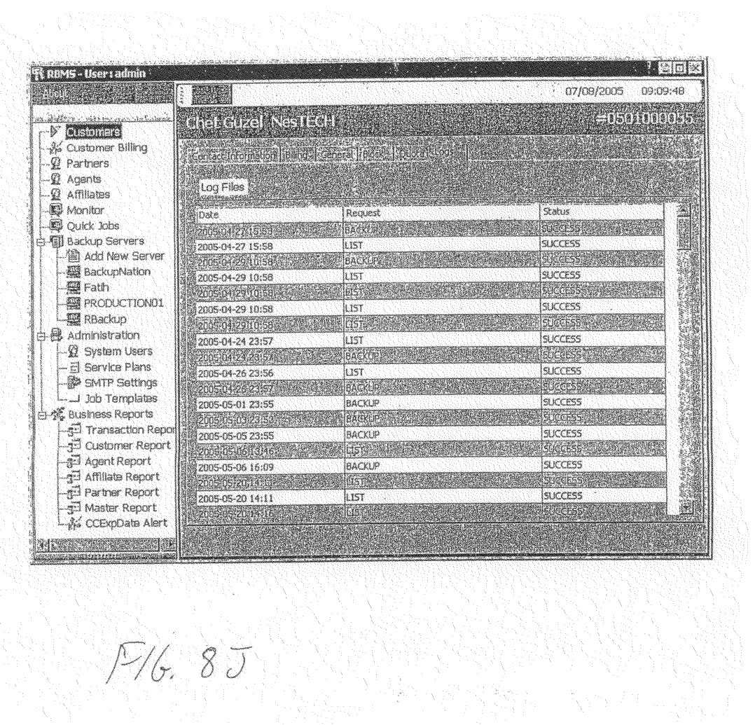

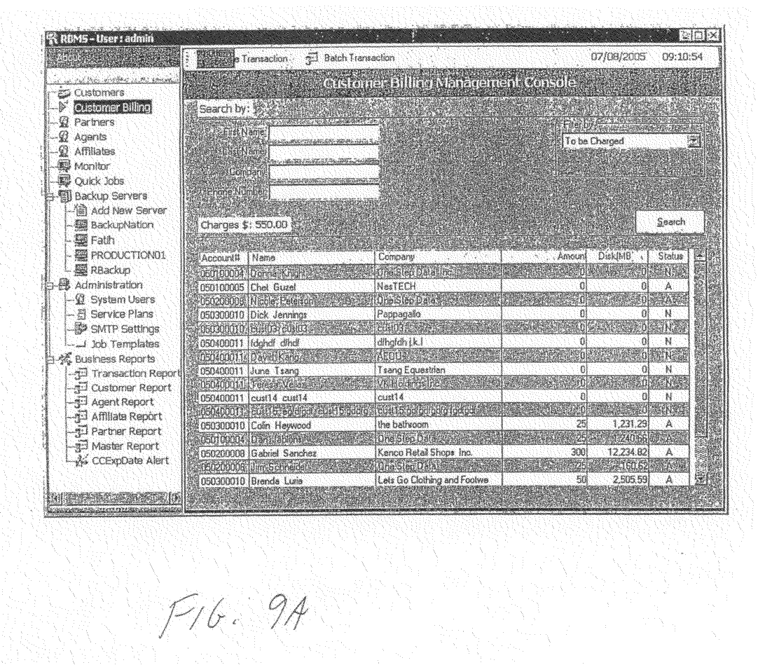

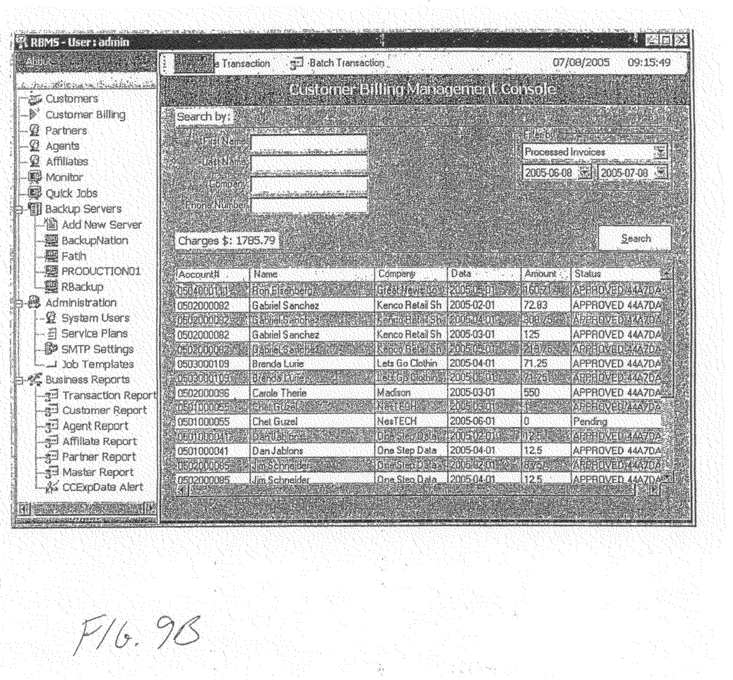

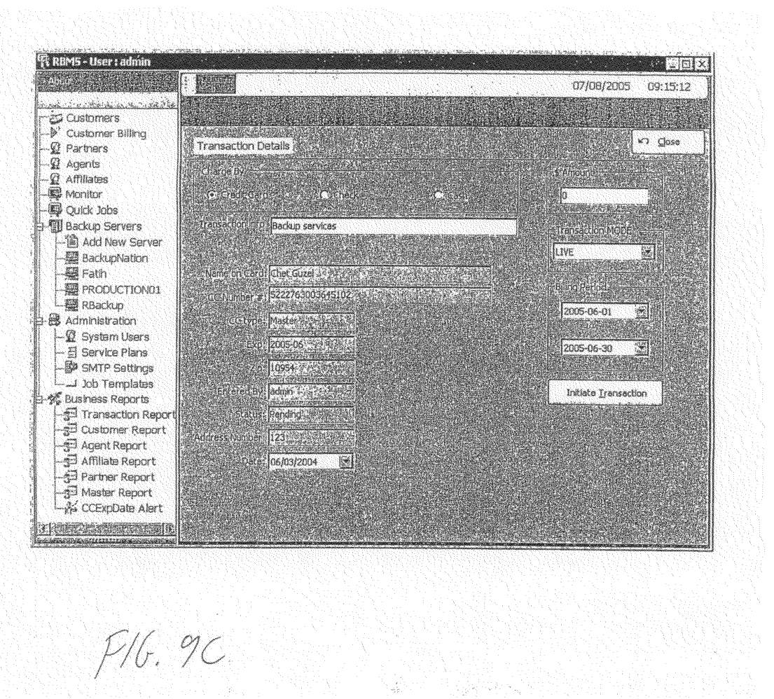

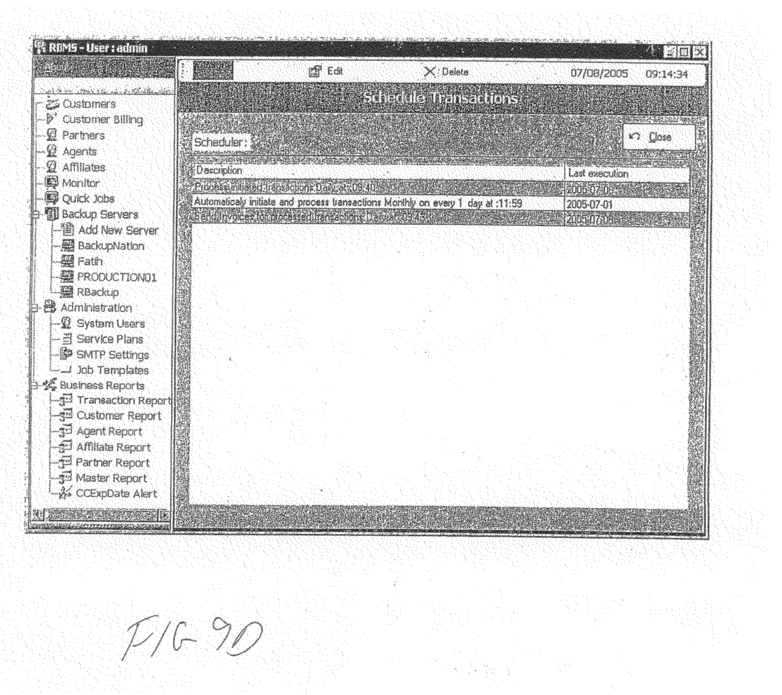

Referring to FIGS. 9A to 9E, screen shots of a customer billing management console are shown. The customer billing management console enables a user to print a list of customers and their payment status, invoice amount, amount of used disk space, and account status in a list form. The customer billing management console also enables the user to print the total charge for a time interval. Right clicking enables user to select other fields to add to the list view. A user can search by first name, last name, company name, and phone number. A list view can be filtered by “to be charged” or “processed invoices” by time interval. The customer billing console enables a service provider to calculate charges, create batch, or single transactions, payment not received alerts to a service provider and to the customer, check for invalid payment type, communicate with payment gateways to submit the charges, and send an invoice to a customer. The customer billing management console also enables the user determine the level of service plan a customer subscribed to, and calculate a service charge for the service term.

The customer billing management console is designed to charge all customers at once for the service period (daily, monthly, quarterly, or yearly), and send the charges to merchant bank payment gateways. The application server 115 is compatible with any file format and any type of payment gateway on the Internet.

The customer billing management console enables a user to create, schedule, and edit various process events. Such events include: “Process initiated transactions every day” and “at this hour”, “Send Invoices for processed transactions every day” and “at this hour”, “Process initiated transactions every week on the day”, where Sunday through Saturday is selectable simultaneously, and “Auto Initiate transactions every 1 through 31 day of the month” and “at this hour”.

The customer billing management console enables the user to schedule functions to run at a time that is scheduled (this could be daily, monthly, quarterly, yearly and multi-yearly, This process gathers and calculates all the charges as a batch and submits the charges all at once to the merchant bank payment gateways of choice. If need be, the application server 115 employs a function that allows a single charge at a time to be made manually.

The customer billing management console enables the user to make a list of customers whose payment method expired, have incomplete payment info, or have a declined payment. In any of these cases the user will send email with the “send mail now” button to remind the customer with a request for payment, a need for a payment method update or change. The user can select to send the message to one customer or multiple customers with one mouse click.

The customer billing management console enables the user to produce invoices in the HTML, simple text, or adobe PDF format The customer billing management console enables the user to send invoices automatically via email or fax. The customer billing management console employs a scheduler function that is utilized to automatically send invoices to customers. The process can be scheduled (any time: hourly, daily, weekly, monthly, yearly, multi-yearly). Everything that is generated by application server 115 or client 140 is written to application database 140 to keep history logs and/or data history.

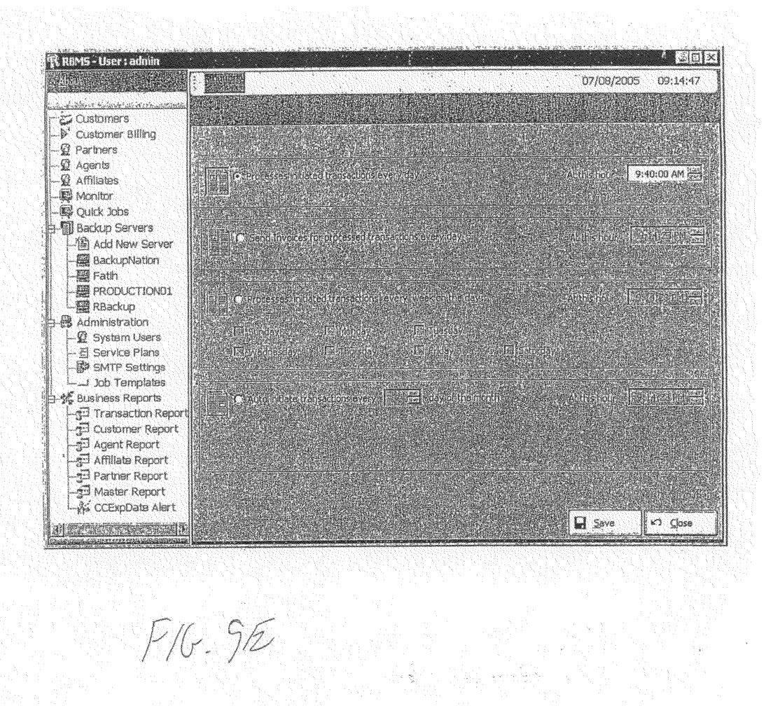

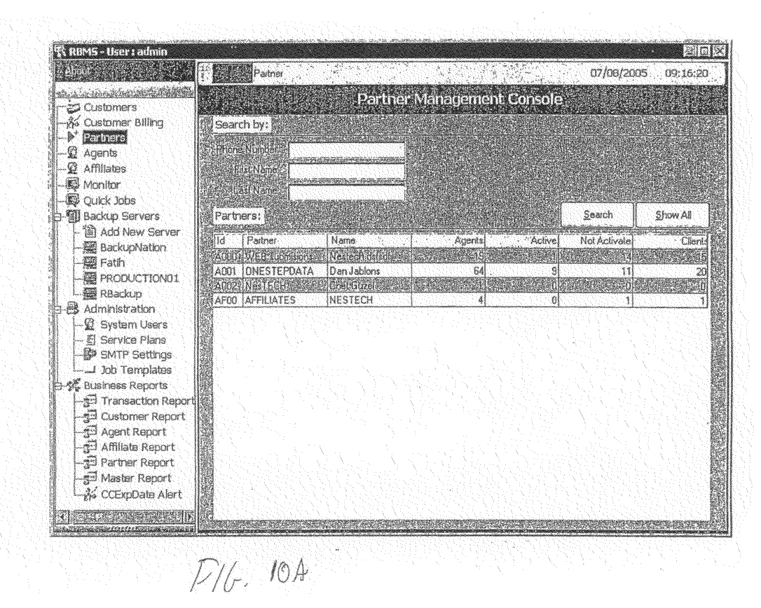

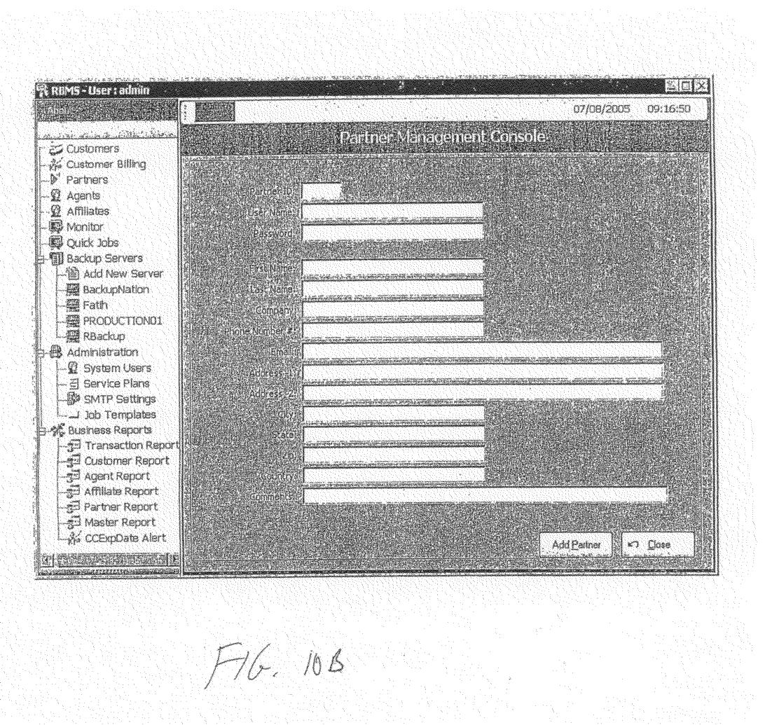

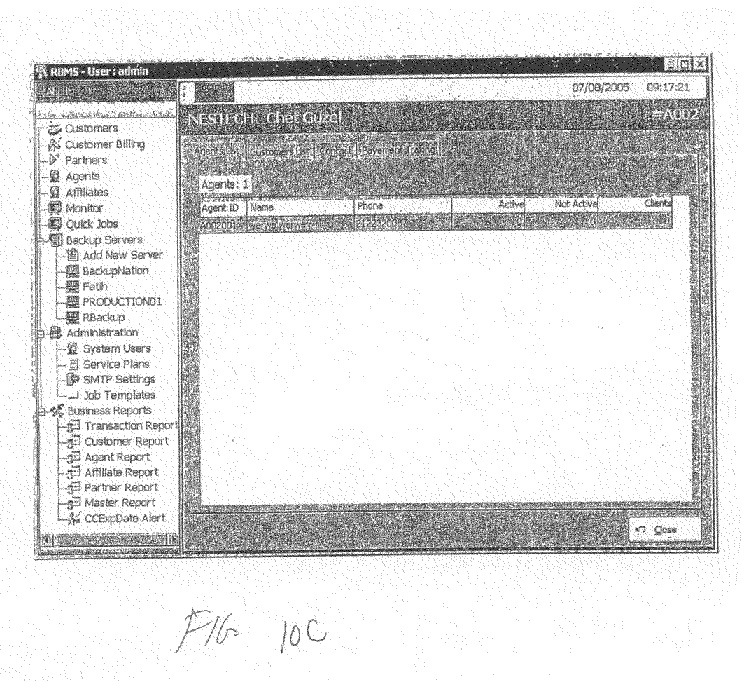

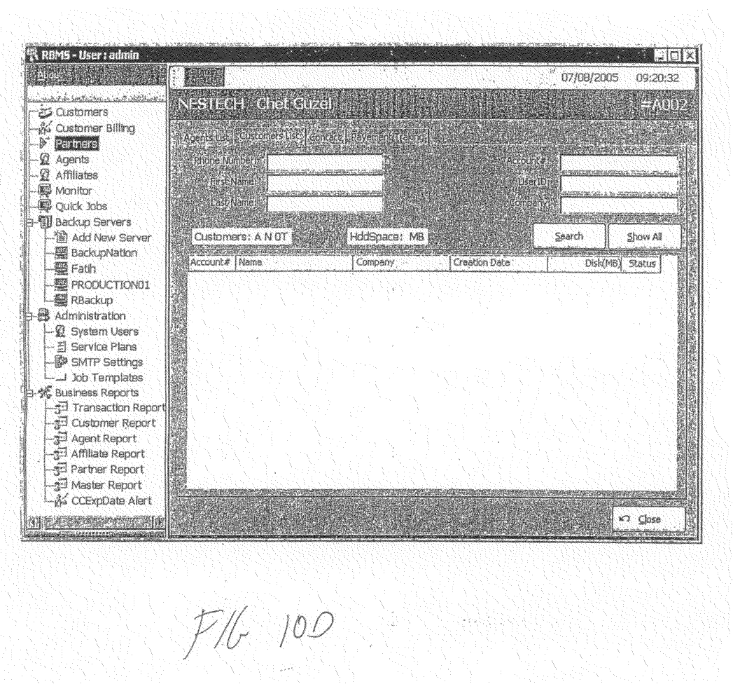

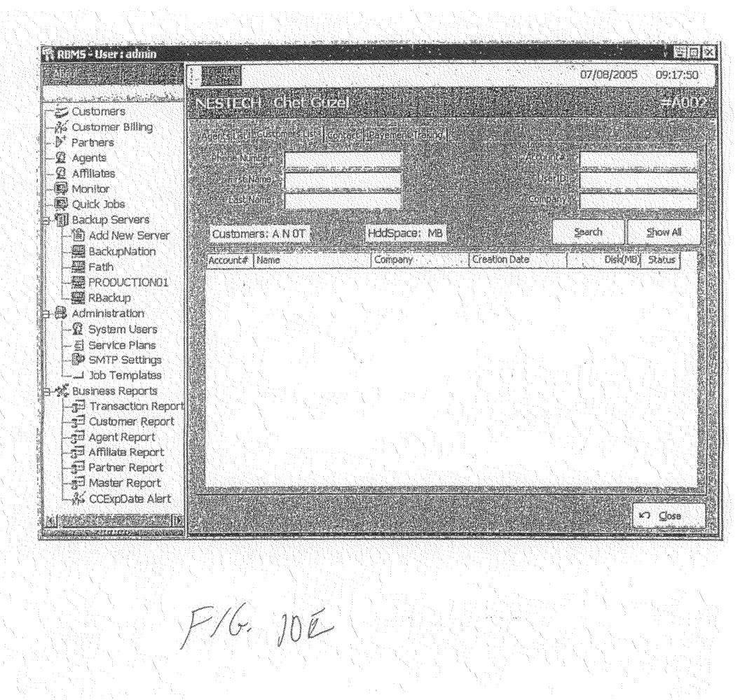

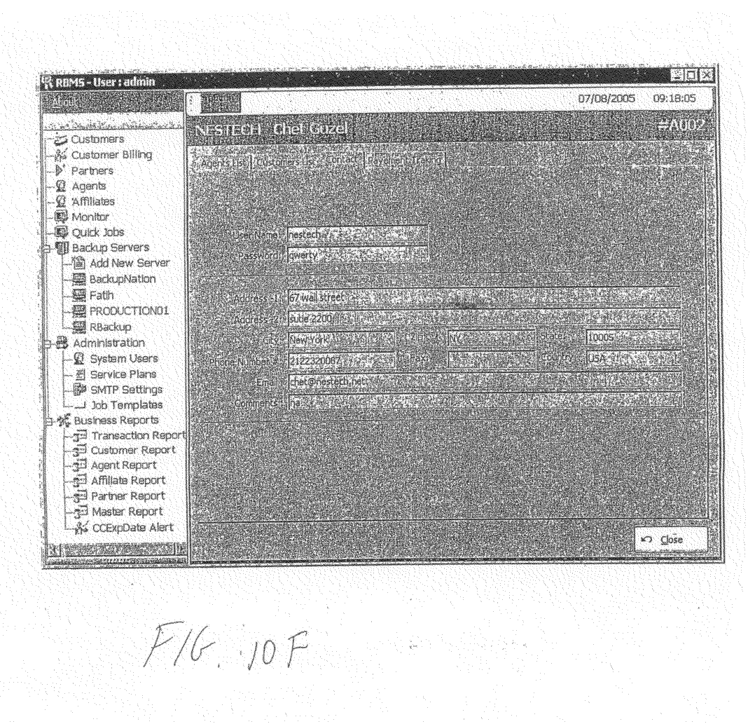

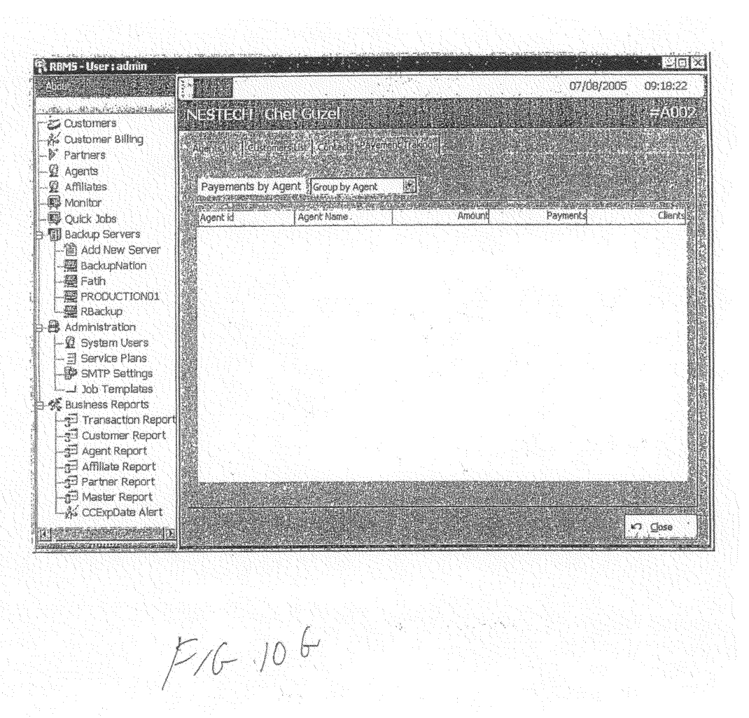

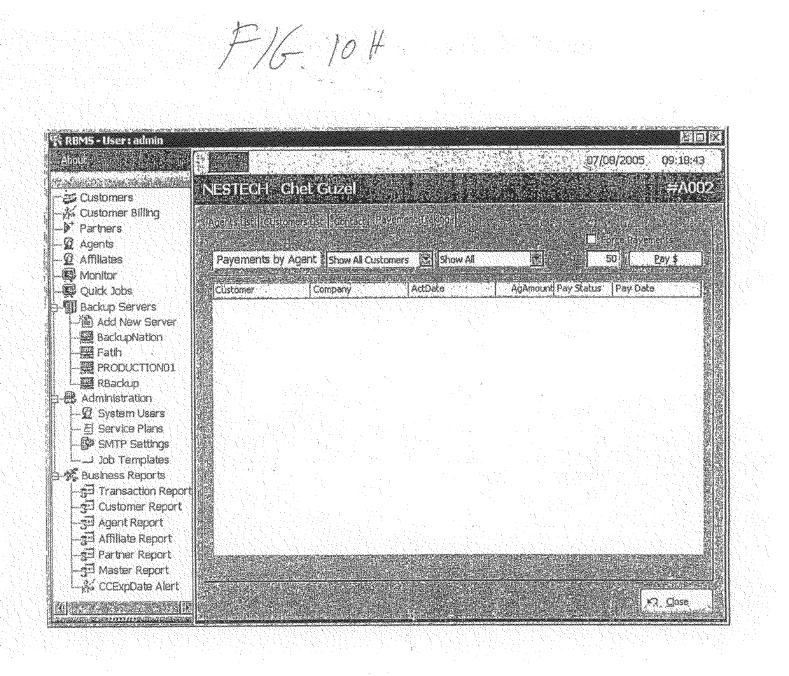

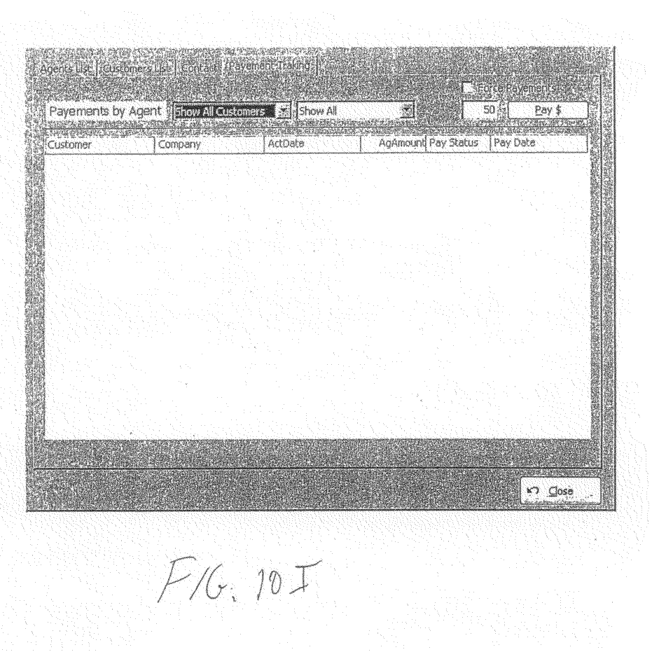

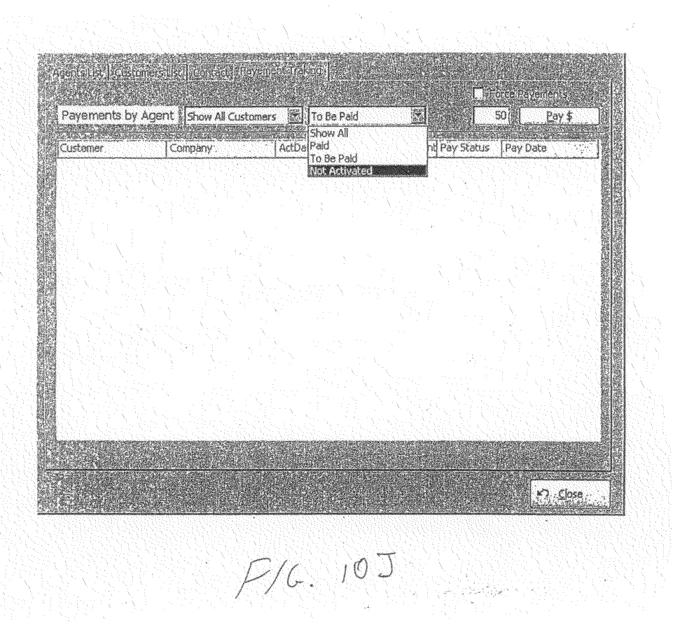

Referring to FIGS. 10A-10J, in one embodiment, screen shots of a partner management console are shown. The partner management console enables a user to print a list of partners and each partner's ID, name, agent count, active or not active status, and total client count The user can create a new partner. Right clicking enables user to select other fields to add to the list view. The user can search by phone number, first name, last name, and company name. The user can click the “Show All” button to list all partners in a list, which is in clickable form. Double or right clicking the menu will display a partner property where the user can see the partner information in detail. The displayed information is in tab form and includes agent list, customer list, contact, and payment tracking.

The “agent list” tab, when selected, lists a summery field of all the agents under the partner. This tab also displays total count of agents on the screen, agent ID, agent name, phone number, active client of the agent, not active clients of the agent, and total clients of the agent

The “customer list” tab, when selected, employs the same functions with the customer management console described above but will display only all the customers that link to a particular partner.

The “contact” tab, when selected, displays user id, password, and contact information of a partner. The “partner tracking” tab, when selected, displays the relationship of the service provider with its partner and partner's agents. If the customer activates its account, the system will automatically set the partner or the agent of the partner or the affiliate who referred the business to the service provider to paid status. If the user had to activate the customer then this has to be set manually, and is described in “forced payments” below.

The “group by agent” tab, when selected, displays a summary of the agent outlook where the user can see agent ID, agent name, payment amount (by service provider to agent) made to the agent, number of payment so far, and total number of clients that the agent has referred to the service provider.

The “show all customers” tab, when selected, displays all the customers the partner (by its agents) referred to the service provider. The “show all” tab, when selected, displays customer name, company, active user, agent payment amount, payment status, and payment date (to the agent for that client for referring business to the service provider).

The “paid” tab, when selected, displays a list of all the customers the partner or its agents has already paid for. The user can see the list of payments made to the agents for each of the customers they have referred. The list includes: customer name, company name, customer activation date, payment amount to the agent, payment status (paid or not), and payment date. The “to be paid” tab, when selected, displays the list of payments due to the partner or the agent of the partner.

The “not activated” tab, when selected, displays the list of the clients that were referred by the partner or the agent of the partner and not activated yet. The “force payment” tab, when selected, enables the user to manually set the payment for a partner, agent of a partner, and affiliate by entering how much the service provider will pay. The user clicks the “Pay $” button to record the status. The system will pay the partner or agent of the partner or affiliate manually or by electronic bank. Electronic banking and bill payment procedures are handled by the electronic banking module of application server 115.

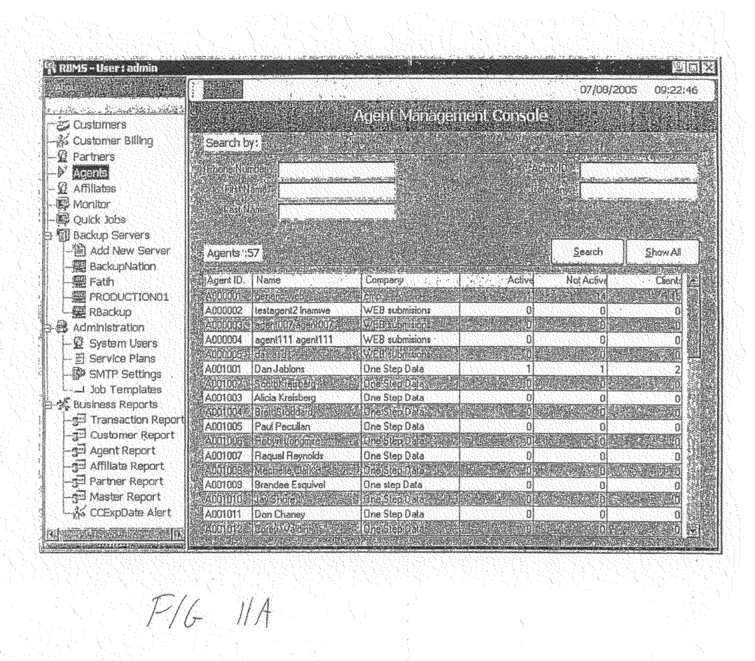

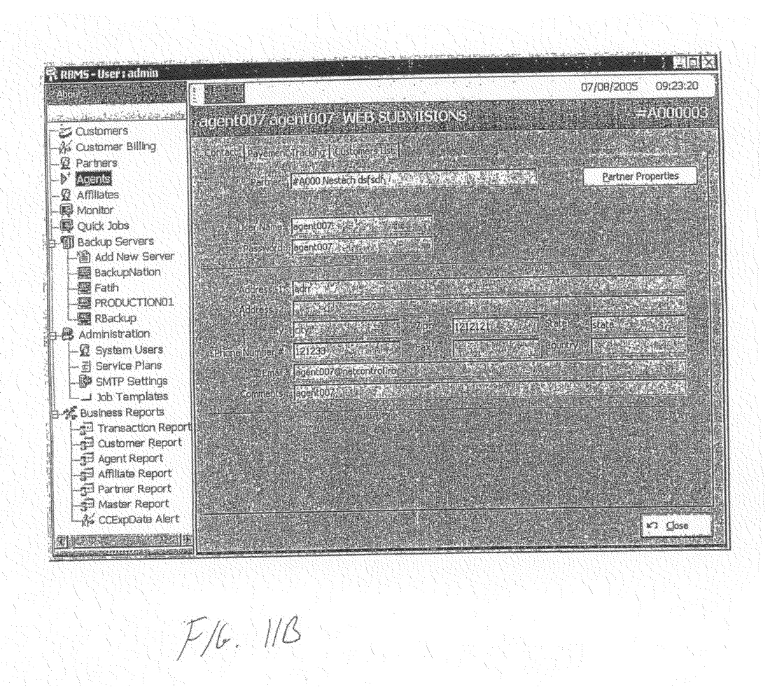

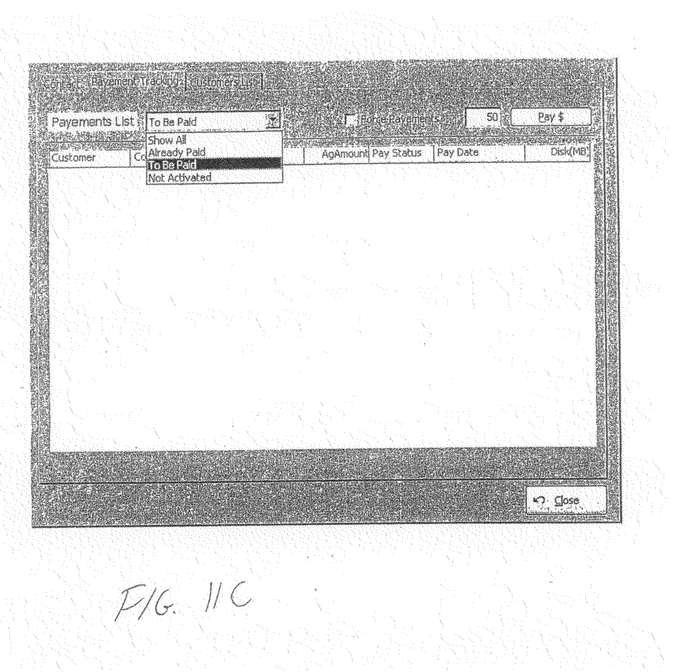

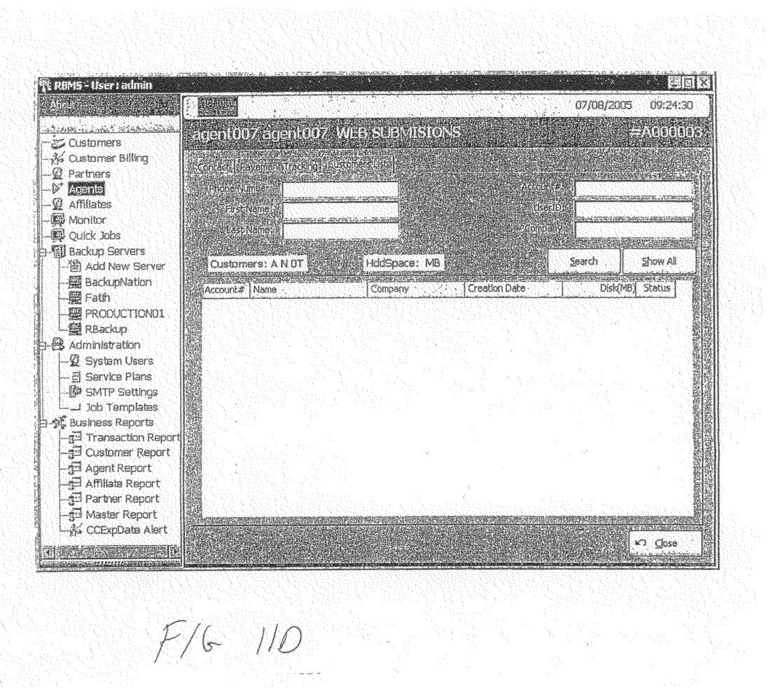

Referring to FIGS. 11A-11D, in one embodiment, screen shots of an agent management console, are shown. The agent management console enables the user to list all the agents, total agent count, each agent's ID, name, agent count, active or not active status, and total client count. The user can also create a new agent Right clicking enables the user to select other fields to add to the list view. The user can search by phone number, first name, last name, agent ID, and company name. Double or right clicking the menu displays the agent properties where the user can see agent details and each agent's information in tab form. The tabs include contact, payment tracking, and customer list.

The “contact” tab, when selected, displays user id, password, and contact information of the agent. The “agent tied to a partner” tab, when selected, displays details of the partner whom the agent works for. When the button clicked the function takes user to partner property page in the partner management console. The “payment tracking” tab, when selected, displays the relationship of the service provider with an agent. If the customer activates its account the system will automatically set the agent or the affiliate who referred the business to the service provider to paid status. If user had to activate the customer then this has to be set manually, and is described below. The “show all” tab, when selected, displays customer name, company, active user, agent payment amount payment status, and payment date (to the agent for that client for referring business to the service provider).

The “already paid” tab, when selected, displays a list of all the customer's agents already paid for. The user can see the list of payments made to the agents for each of the customers they referred. The list includes customer name, company name, customer activation date, payment amount to the agent payment status (if the agent is paid or not), and payment date. The “to be paid” tab, when selected, displays the list of payments due to the agent. The “not activated” tab, when selected, displays the list of the clients that were referred by the partner or the agent of the partner and not activated yet.

The “customer list” tab, when selected, employs the same functions with the customer management console described above but will display only all the customers that link to a particular agent. The “force payment” tab, when selected, enables the user to manually set the payment for a partner, agent of a partner, and affiliate by entering how much the service provider will pay. The user clicks the “Pay $” button to record the status. The system will pay the partner or agent of the partner or affiliate manually or by electronic bank. Electronic banking and bill payment procedures are handled by the electronic banking module of application server 115.

The affiliate management console enables the user to list all the affiliate, total affiliate count, each affiliate's ID, name, affiliate count, active or not active status, and total client count. The user can also create a new affiliate. Right clicking enables the user to select other fields to add to the list view. The user can search by phone number, first name, last name, agent ID, and company name. Double or right clicking the menu displays the affiliate properties where the user can see affiliate details and each affiliate's information in tab form.

The “contact” tab, when selected, displays user id, password, and contact information of the affiliate. The “payment tracking” tab, when selected displays the relationship of the service provider with an affiliate. If the customer activates its account, the system will automatically set the affiliate or the affiliate who referred the business to the service provider to paid status. If user had to activate the customer then this has to be set manually, and is described below. The “show all” tab, when selected, displays customer name, company, active user, agent payment amount, payment status, and payment date (to the agent for that client for referring business to the service provider).

The “already paid” tab, when selected, displays a list of all the customers affiliates already paid. The user can see the list of payments made to the affiliates for each of the customers they referred. The list includes customer name, company name, customer activation date, payment amount to the affiliate, payment status (if the affiliate is paid or not), and payment date. The “to be paid” tab, when selected, displays the list of payments due to the affiliate. The “not activated” tab, when selected, displays the list of the clients that were referred by the partner or the affiliate of the partner and not activated yet.

The “customer list” tab, when selected, employs the same functions with the customer management console described above but will display only all the customers that link to a particular agent. The “force payment” tab, when selected, enables the user to manually set the payment for a partner, agent of a partner, and affiliate by entering how much the service provider will pay. The user clicks the “Pay $” button to record the status. The system will pay the partner or agent of the partner or affiliate manually or by electronic bank. Electronic banking and bill payment procedures are handled by the electronic banking module of application server 115.

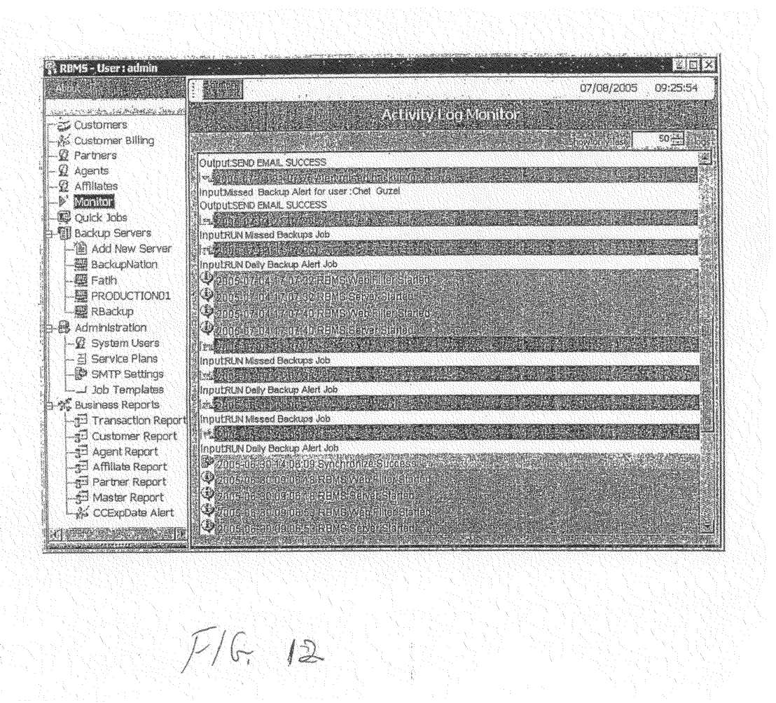

Referring to FIG. 12, in one embodiment, is a screen shot of an activity log monitor console is shown. The activity log monitor console displays every event that occurred, user actions, and customer actions. The list includes operation date, input data, output data, operation type, operation descriptions, and a list of who is currently in the process of backing up. The operation types include: missed backup events and scheduled events, server events, email and web communications, log displays, and user and customer notifications.

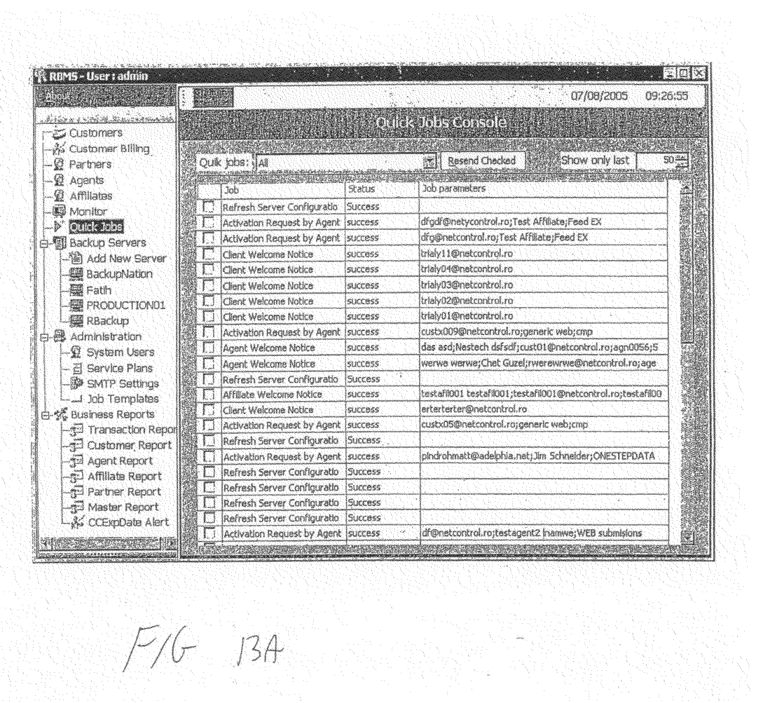

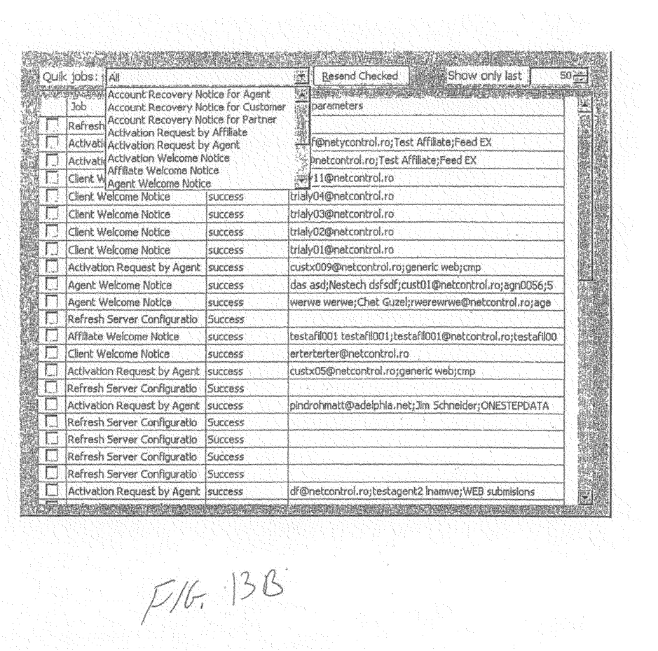

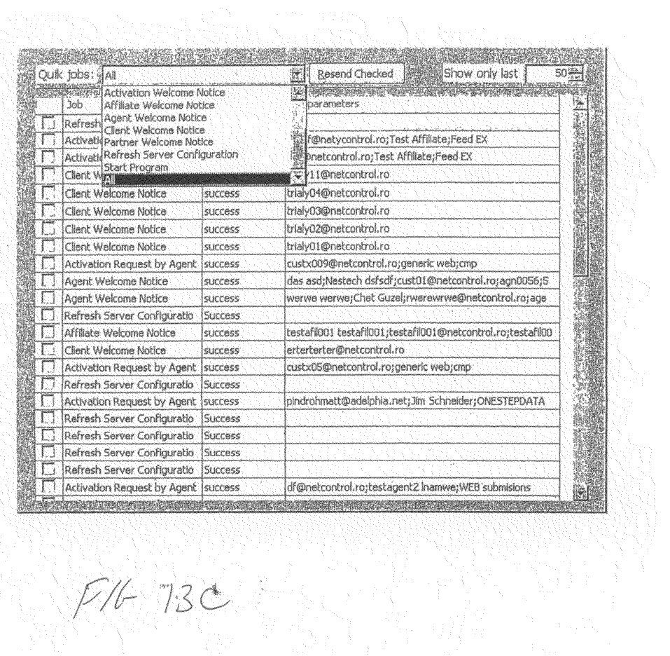

Referring to FIGS. 13A to 13C, in one embodiment, a quick jobs console is shown. The quick jobs console enables a user to re-execute actions that have already been automatically executed and need to be manually executed.

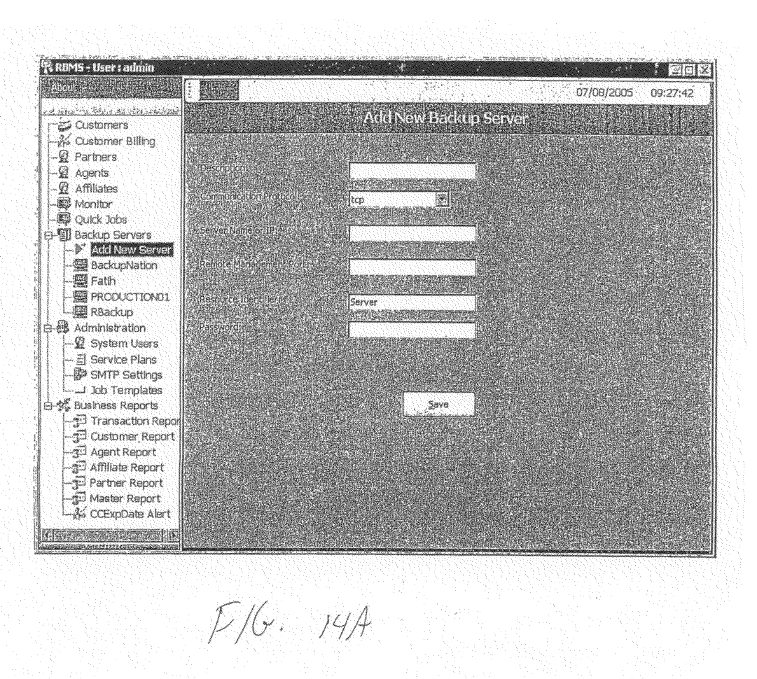

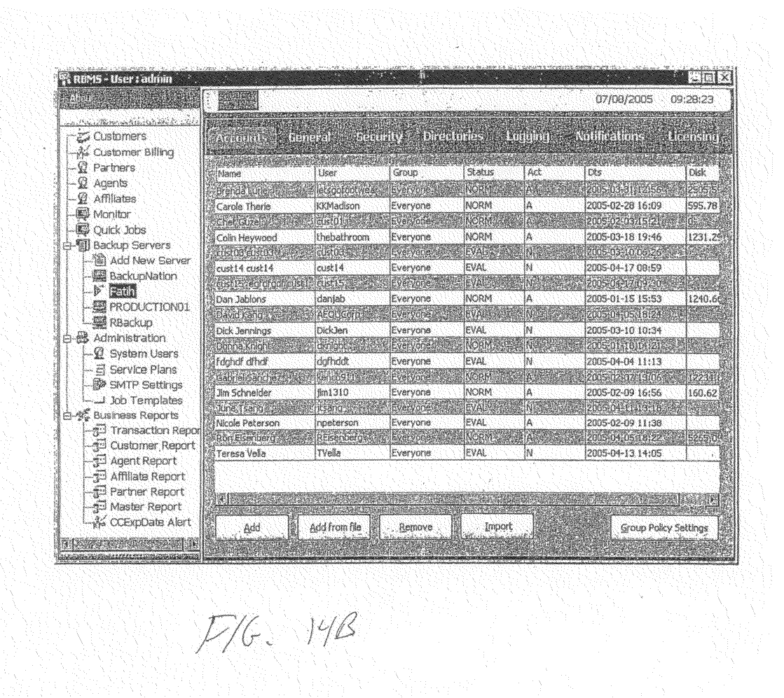

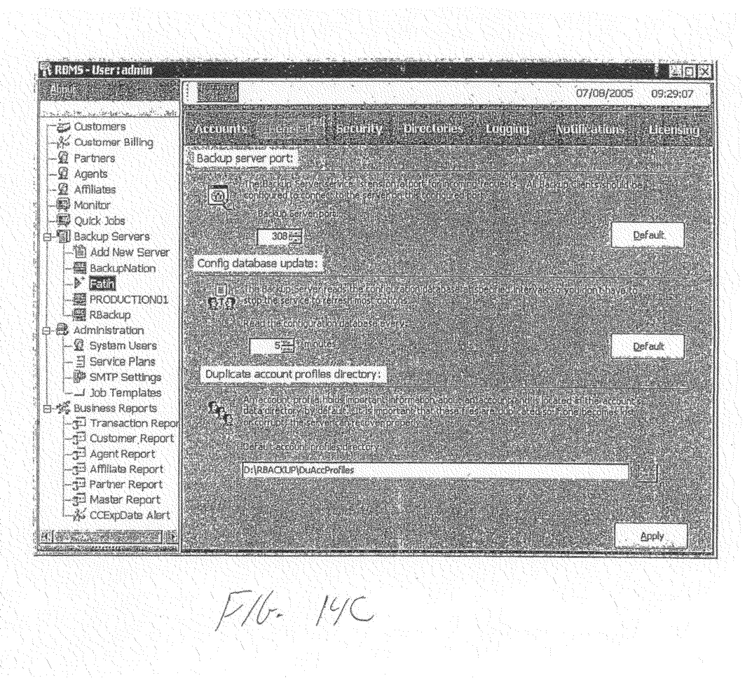

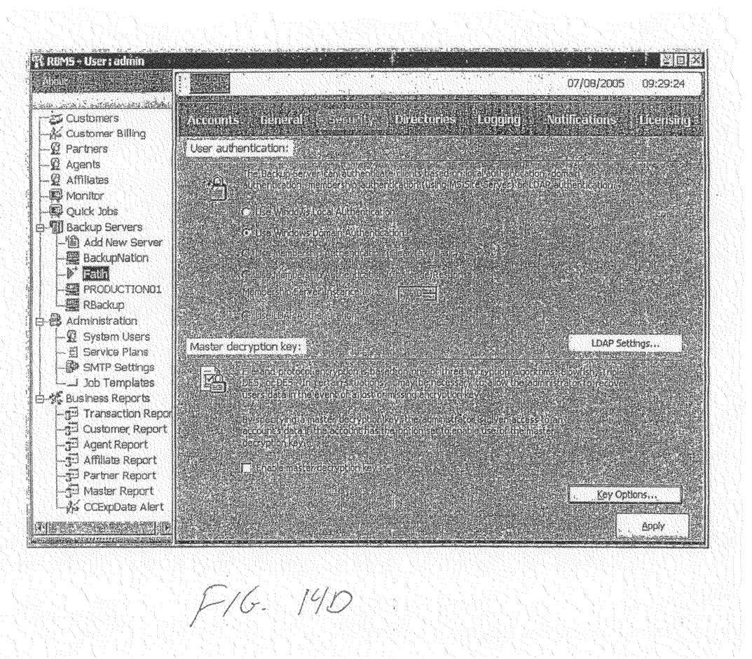

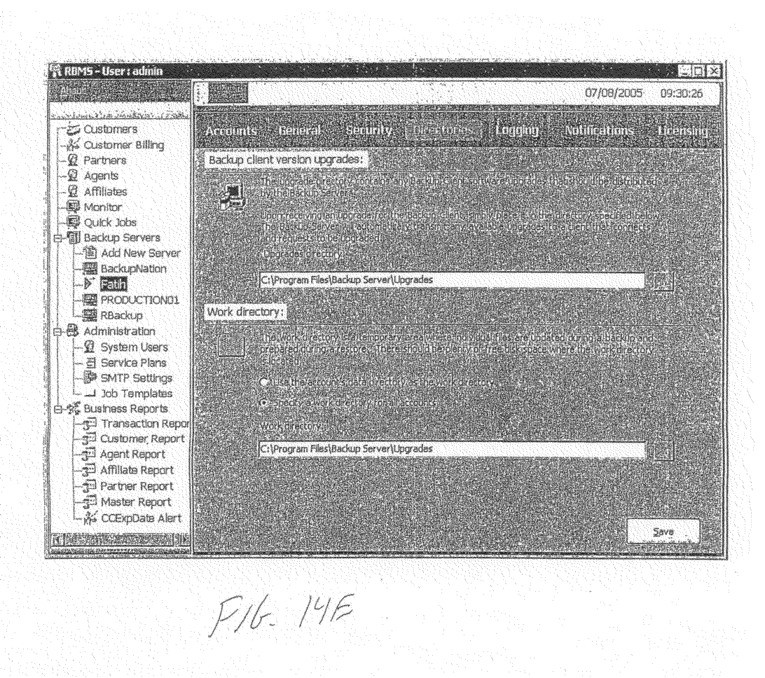

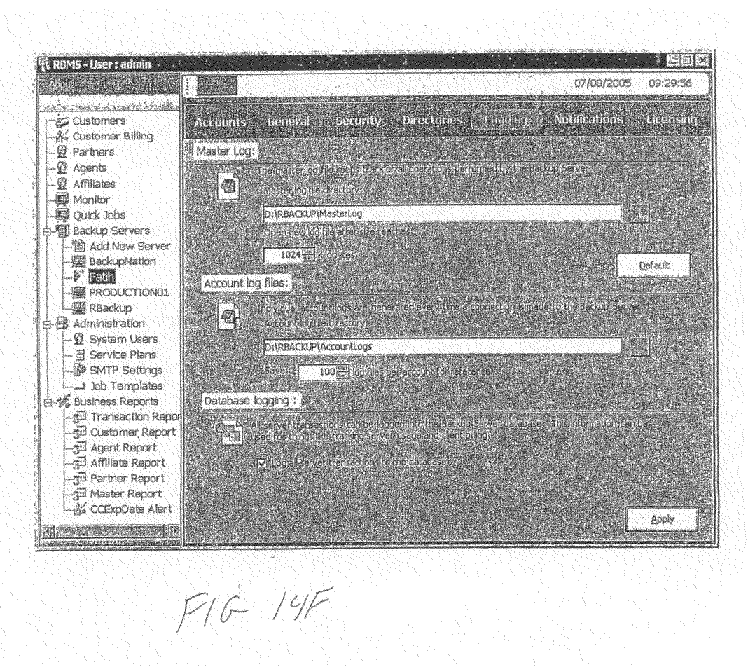

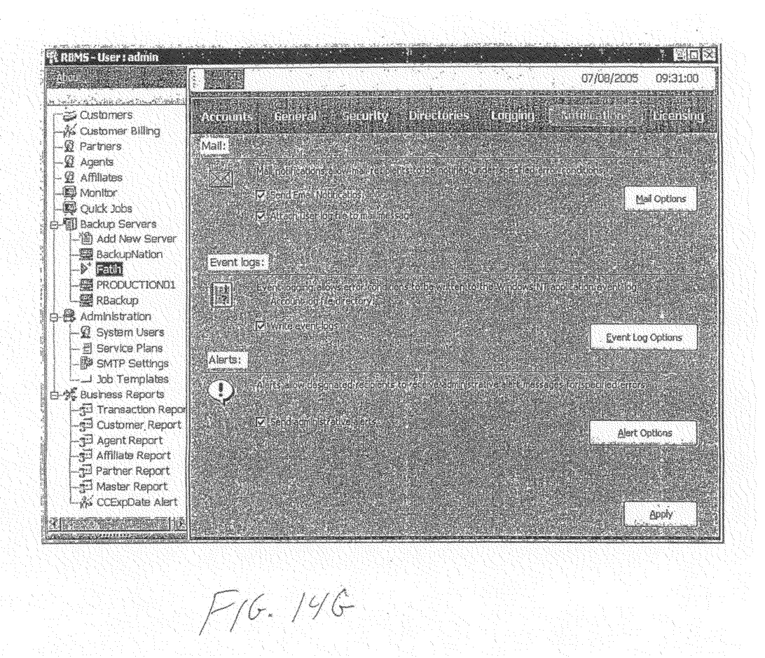

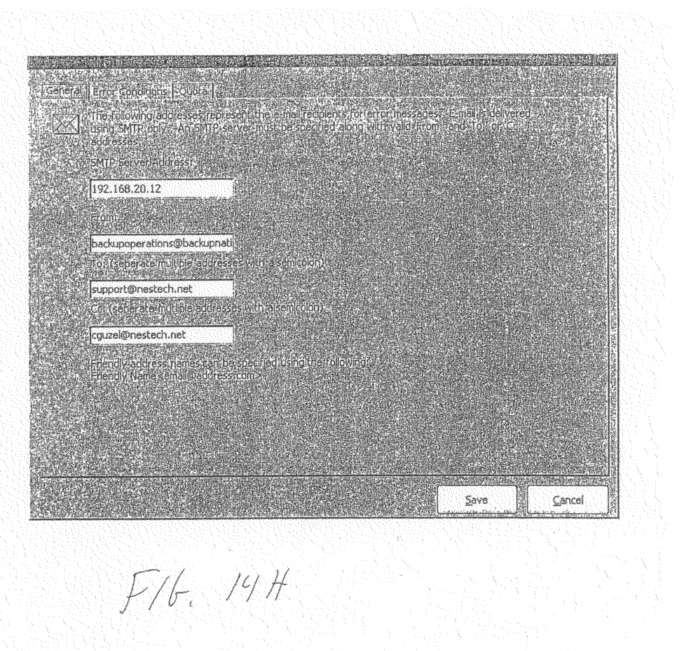

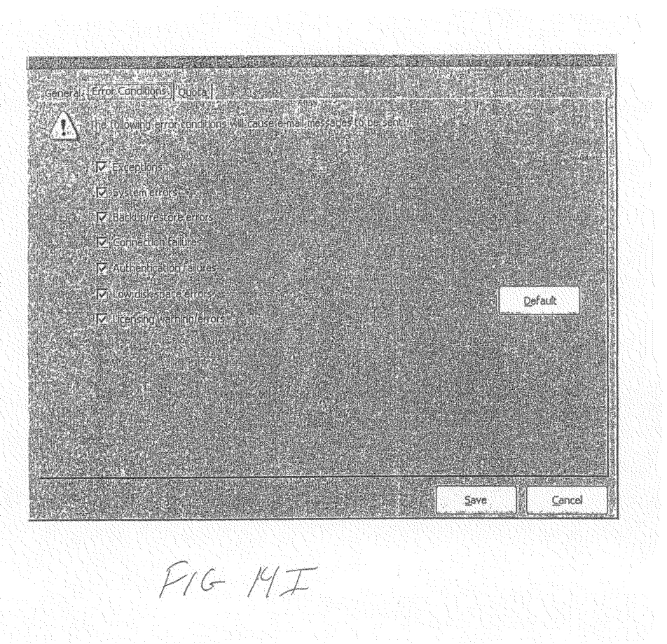

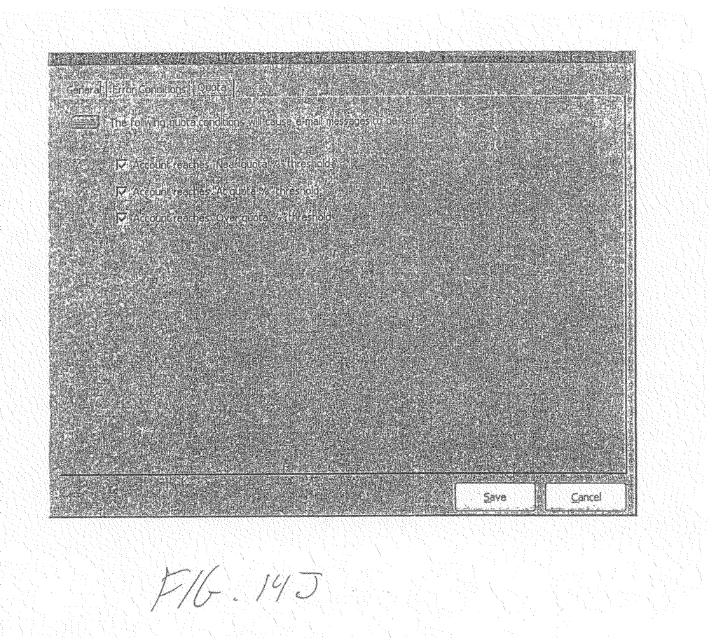

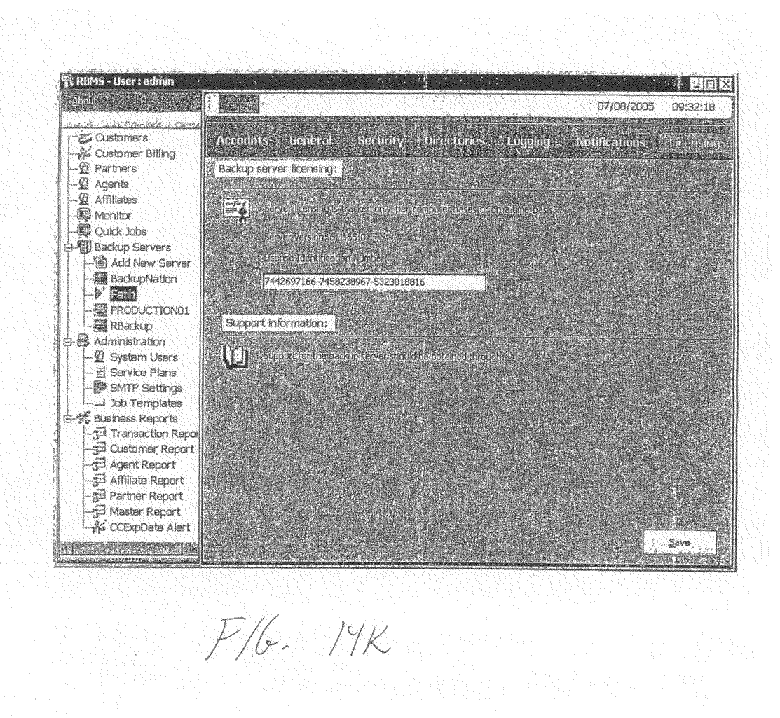

Referring to FIGS. 14A to 14K, in one embodiment, screen shots of a server management console are shown. The server management console enables a user to add new servers to the management console and maintain them. The server management console also allows the user to make changes to the system, change settings, and monitor servers. Once a server is added, the server name will be displayed in the menu under “server management”. Clicking on the added server on the server management console allows the user to see, edit, modify, or delete server functions.

The “add” button enables a user to add and authenticate a new customer account to the backup server. This function also lists the accounts that are on the server. The columns are bound to the fields in the database. Double clicking on a customer user account will display the customer management console. The “add from a list” button enables a user to add multiple accounts at the same time by reading the account info from a file (e.g., txt, xls, doc, etc.). The “remove” button enables a user to remove an account from the server, authentication server, and account data that are in the network. The “import” button enables a user to import data from other data sources into application database 140. The “group policy” button enables a user to create, edit, or modify new group policy in the system to ease customer management. The “generate” button enables a user to create a new policy buy group name, description, and new group name. The “block” tab enables a user to setup service or feature blocks to customer account.

The “quota” tab enables a user to set a global quota to the storage of the customers who may be added to this group. The “general” button enables a user to set ports, configure database updates, and duplicate account profile directory settings. The “security” button enables a user to set authentication methods and enable master decryption keys. The “directories” button enables a user to setup, add, replace, and edit directories of files on the server. The user can also select where upgrades to the backup client will be, where temporary files should be replaced by the system while it is working on them. The “logging” button enables the user to select where the muster logs should reside and added, what the maximum log size should be, and if the size is exceeded, when the system will create and start a new log file. The user can also select the directory where the customer account log files would be added to, and what database to log all the server transactions.

The “notification” button enables the user to send a mail notification of an event, such as customer backup is done successfully, missed backup, backup not successful, etc. The event log portion enables the user to select a function that allows the server events to be displayed in event logs. The user can send alerts to an administrator in case of a server event. The “licensing” button enables the user to add, edit, or delete product licenses.

The administration console enables the user to control the business service plans, access rights, control server settings, and control job template settings.

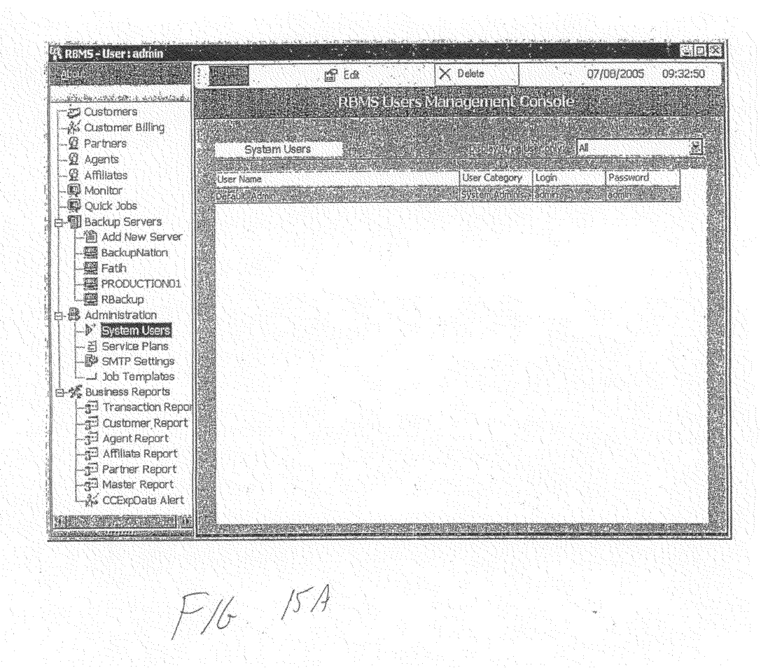

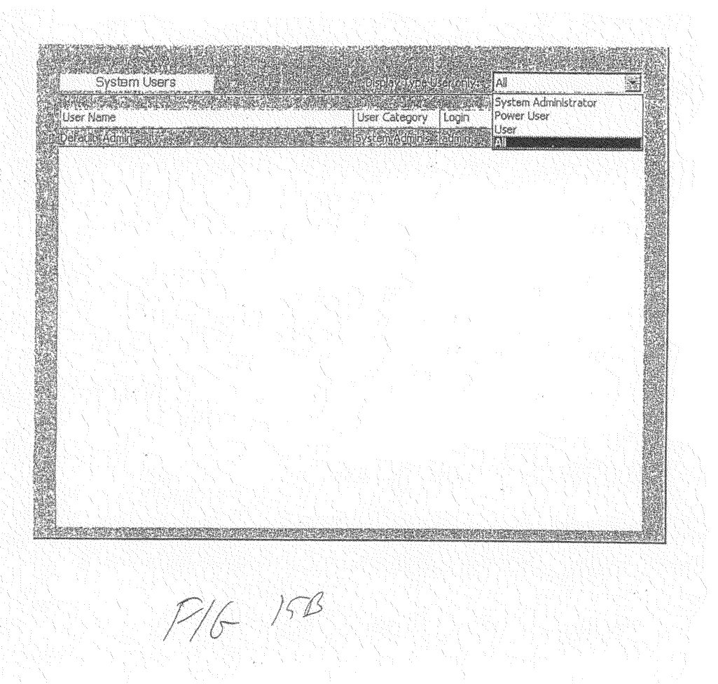

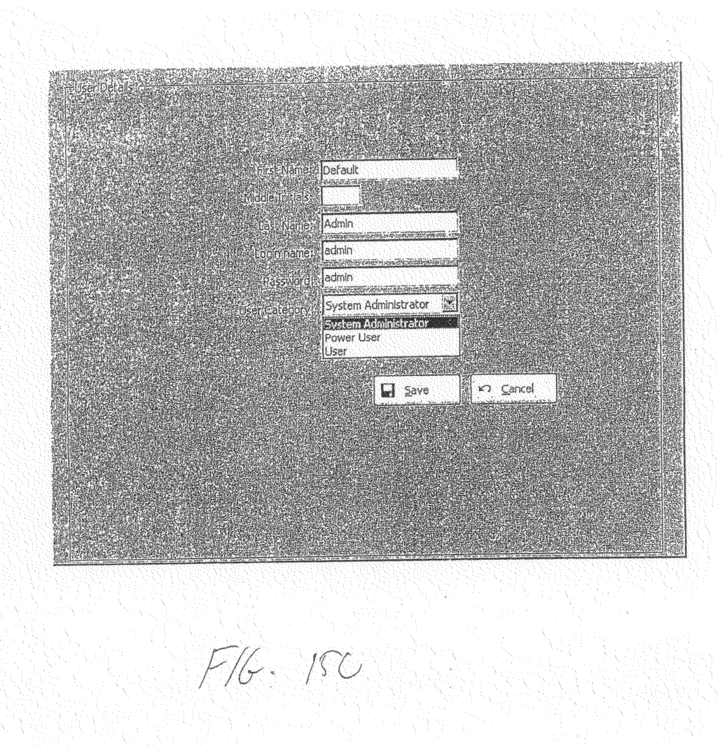

Referring to FIGS. 15A to 15C, in one embodiment, screen shots of a user management console are shown. The user management console enables a user to set other users' permission and rights. The user is also able to filter added users according to need.

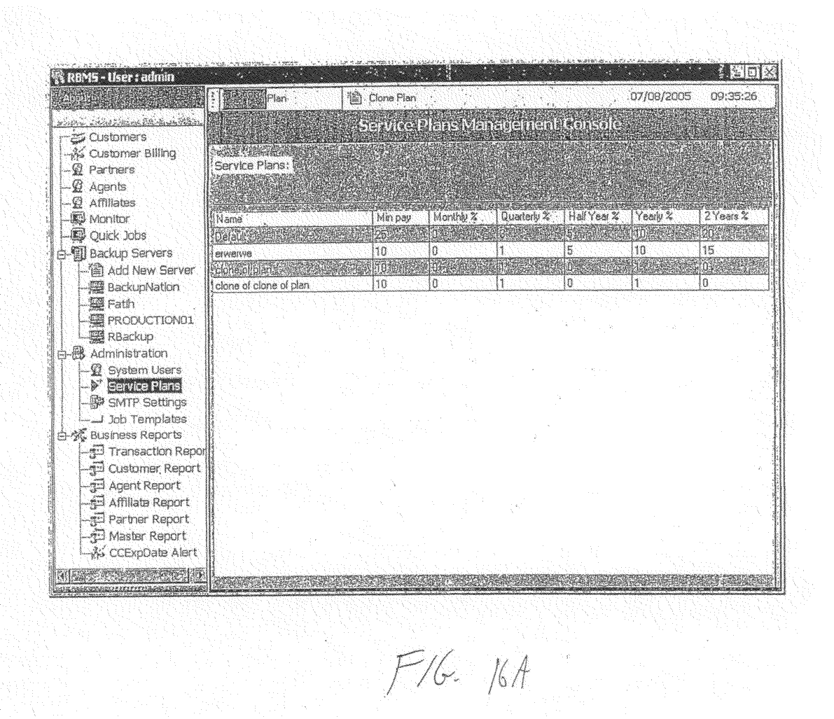

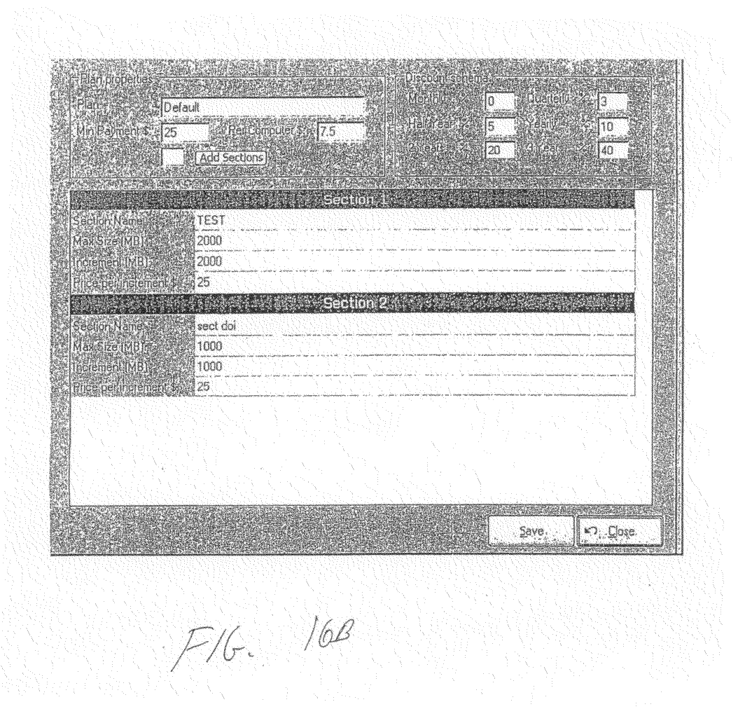

Referring to FIGS. 16A to 16B, in one embodiment, screen shots of a service plans management console, are shown. The service plans management console allows user to see a list of the service plans. Double or right clicking a property displays the service plan property page that allows a business to setup their service plan, service plan name, discounts per term, promotions, rates, and service levels etc. The user is able to add as many service plans by depressing “Add Section” button. This allows a business to run different levels of services for different customers simultaneously.

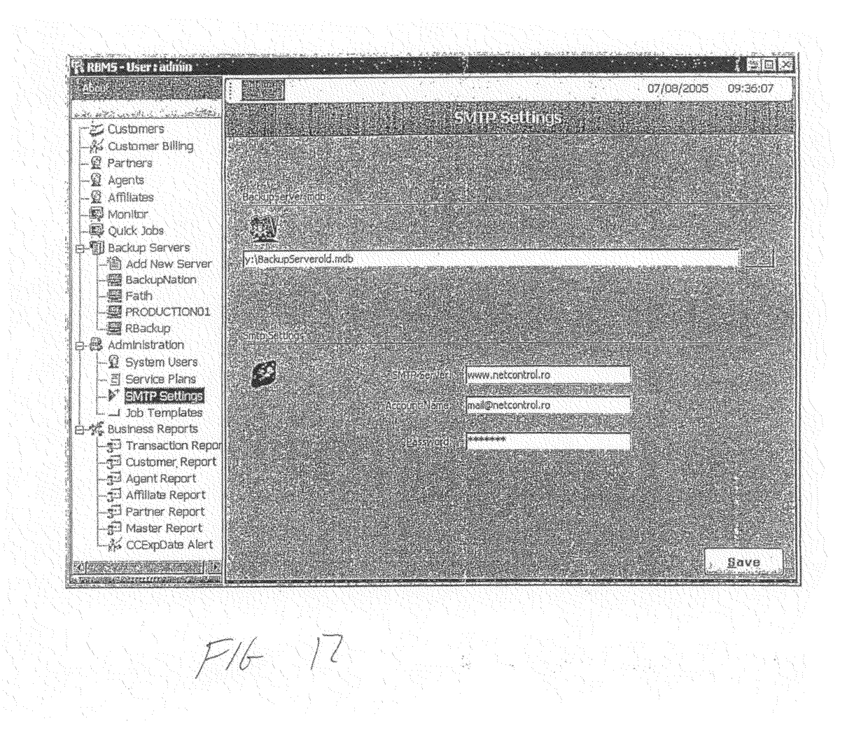

FIG. 17 is an illustrative screen shot of a SMTP settings console, according to one embodiment of the invention. The SMTP settings console allows user to set a company profile for service provider, where all the templates (email communications, fax communication, invoices, notices, etc.) would use the information automatically. For email communication specifications, SMTP setting would be used so all the customers, partners, agents, and user communications are processed thorough the application server 115. The SMTP settings console also employs synchronization setting. If there is any third party database that needs to be synchronized with the application database 110, the user enters the information so the application server 115 synchronize application database 110 with the third party database.

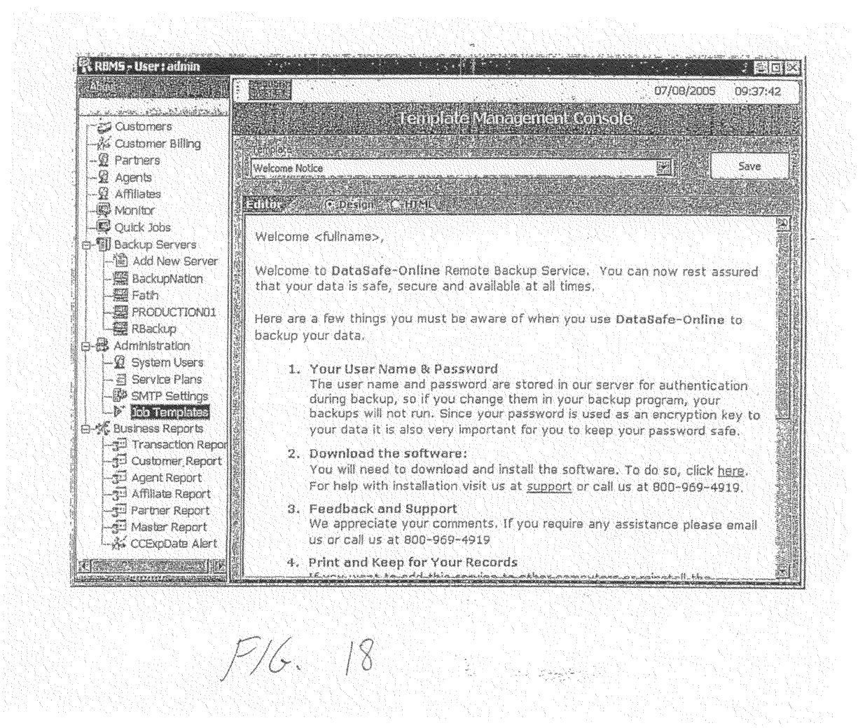

FIG. 18 is an illustrative screen shot of a template management console, according to one embodiment of the invention. The template management console is fully customizable by a user and consists of the email massaging, alerts, notices, news, etc.

The business report console enables a user to gather and print various reports. The user can gather, view, and print transaction, customer, partner, agent, affiliate, master, and credit card reports.

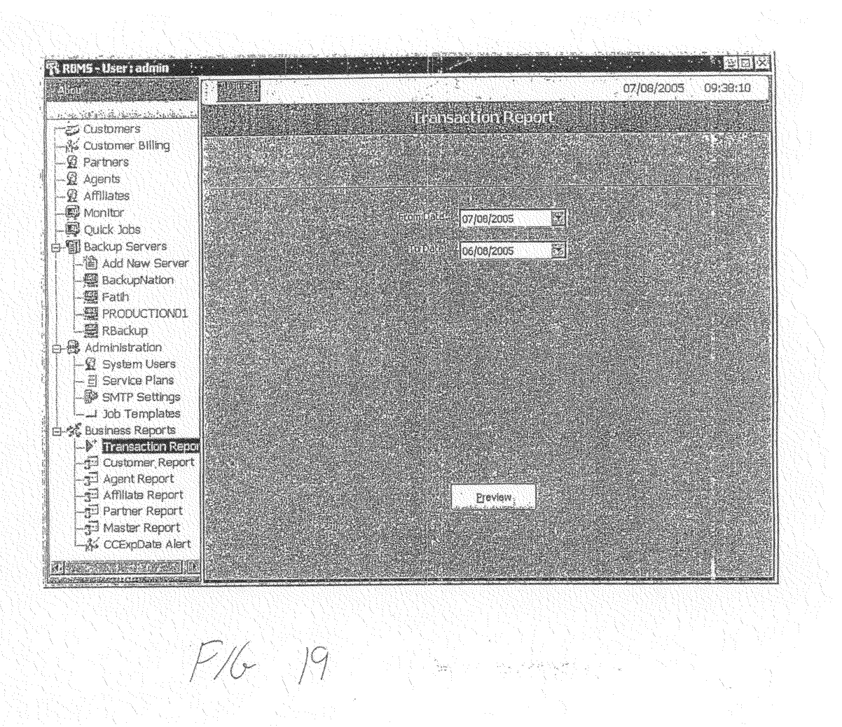

Referring to FIG. 19, in one embodiment, a screen shot of a transaction report console is shown. Data is gathered by the application server 115 and printed on a report screen. This report displays a customer's name, company, phone, charge, result of the charge (approved, denied), and size of the data stored.

For a customer report, data is gathered by the application server 115 and printed on a report screen. This report displays customer's name, company, data size, status (active, not active), and account creation date.

For an agent report, data is gathered by the application server 115 and printed on a report screen. This report displays agent name, company, his/her total customer, status (active, not active) data size, paid amount, to be paid amount, paid number, and to be paid number.

For an affiliate report, data is gathered by the application server 115 and printed on a report screen. This report displays affiliate name, company, his/her total customer, status (active, not active) data size, paid amount, to be paid amount, paid number, and to be paid number.

For a partner report, data is gathered by the application server 115 and printed on a report screen. This report displays; partner name, company, total agent number, total paid amount, total paid number, total customer number, and customer status (active, not active).

For a master report, data is gathered by the application server 115 and printed on a report screen. This report displays total customers, total agents, total affiliates, total data storage, and total charges.

For a credit card report, data is gathered by the application server 115 and printed on a report screen. This report displays customer name, phone number, last 4 digit of credit card number, and the credit card expiration date. The report includes data on everyone whose credit card will expire in the next 3 months of the date report is generated.

The website interface 135 is designed to enable the application client 140 to be ran via an Internet browser. The functions of the application client web Interface 135 function the same way as the application client 140.

The website interface 135 allows customers, partners, agents, and affiliates to be able to see, print, add, and modify their information stored in application database 110. The application server 115 (Web Filter) is in between the web server and the application database 110, calculating, organizing, sending, and receiving requests and responses. The communication between web user's computer and web site of the service provider is secured with SSL protocol. Customers, partners, agents, and affiliates each have their own screens, information, and functions they can initiate.

The website 135 is also an interface for a first time customer to sign up for the services of a service provider, partner, agent and affiliate. Once the account is created all the entities can log on to the web site and manage their own information via website through the application server 115 and application database 110.

Form the website 135, customers can build custom backup client software by clicking the “download button”, configure the custom backup, and download the software. Configuration parameters include: backup schedule, custom backup set, username and password, backup server IP address or name, backup server port address, and applied filters. The customer can configure event notification by logging in and configuring their account to enable the application server 115 to monitor various events and send email/fax notifications to the customer. Events that can be monitored include: missed backups, failed backups, successful backups, and unsuccessful backups.

A customer can also retrieve his/her data from data storage media of the service provider by installing an ActiveX application that is automatically provided by the web site when the “web restore” button is clicked.

A customer can also change, add, or edit his/her payment method and information. The customer also can see a list of past activities. When a link in this window clicked, the application server 115 retrieves data from application database 110 regarding the request and automatically builds and displays the results on the customer's screen.

A customer can also change, add, or edit his/her contact information that the application server 115 uses to communicate with the customer. A customer can also review a status of his/her backups. The customer can also see the log file of the backup he/she is interested in. A customer can also see a summary of his/her account.

From the website 135, a partner can log in to the service provider's web site to manage their account. A Partner can also add, edit, change, or view account information related to the partner. A partner can initiate a function to receive results of some of his/her account properties.

A partner can also see the list of agents related to the partner and their activity. The information includes: agent ID, agent Name, active or not active status, and total number of clients of the agent whom the agent signed up for the service of the service provider.

A partner can also create new agents. When a partner creates a new agent, the application server 115 sends notification to the agent to invite or distribute news or an update message. A partner can also add or edit its contact information. A partner can also add, edit, and review its user ID and password.

A partner can also view sales commissions its agent was paid or waiting to be paid. Information in this menu includes: agent ID, agent name, amount, payment status, paid amount and total number of agent's clients. A partner can also view and/or download information regarding promotions, server updates, and message.

From the website 135, an agent can log to the service provider's web site to manage their account An agent can also add, edit, change, or view account information related to the agent. An agent can also initiate a function to receive results of some of his/her account properties. An agent can also view a list of customers. The information includes: customer name, company, phone, creation date, and activation dater of the customer. An agent can signup a customer for the service of service provider by entering minimal information about the customer. As the agent creates the account, the application server 115 sends a welcome email/fax to the customer notifying the customer that an agent has created an account for the customer aid invites the customer to complete the registration process. An agent can also add or edit its contact information.

An agent can add, edit, and review its user ID and password. An agent can view his/her sales commissions, whether paid or waiting to be paid. The information includes: customer name, company, total active number of clients, agent payment amount status, and paid date.

From the website 135, an affiliate can log on to the service provider's web site to manage their account. An affiliate can add, edit, or view account information related to the affiliate. An affiliate can initiate a function to receive results of some of his/her account properties. An affiliate can view list of his customers. The list includes: name, company, phone, creation date, and activation date of the customer. An affiliate can add up a customer for the service of service provider by entering minimal information about the customer. As the affiliate creates the account, the application server 115 sends a welcome email/fax to the customer notifying the customer that an affiliate has created an account for the customer and invites the customer to complete the registration process. The affiliate can add or edit its contact information. An affiliate can add and edit its user ID and password. And affiliate can view his/her sales commissions, whether paid or waiting to be paid. The information includes: customer name, company, total active number of clients, and affiliate amount payment status.

Variations, modifications, and other implementations of what is described herein will occur to those of ordinary skill in the art without departing from the spirit and the scope of the invention. Accordingly, the invention is not to be defined solely by the preceding illustrative description.

What is claimed is:

1. A method for automating performance of administrative tasks for a service provider that provides services for customers, the method comprising:
storing information including profile data of each customer of the service provider and information including account metadata representing each customer's use of services provided by the service provider;
organizing the stored information to facilitate automatic retrieval and manipulation of the information in order to perform a particular administrative task;
receiving at least one query from a user to initiate performance of a particular administrative task; and
processing the organized information in response to the at least one query in conjunction with performing the particular administrative task.

2. The method of claim 1, wherein the service provider provides a service comprising remote backing-up of data in a storage device, the metadata information comprising an amount of data space in the storage device utilize by the service provider in backing up data for a particular customer.

3. The method of claim 2, wherein the particular administrative task comprises an automated billing transaction, the method further comprising:
retrieving the metadata information to obtain current use information regarding and amount of data backed-up by the service provider in a predetermined time interval for a particular customer;
calculating a charge commensurate with an amount of data backed-up by the service provider in a predetermined time interval for a particular customer; and
automatically generating an invoice including the charge.

4. The method of claim 3, further comprising transmitting the calculated charge to a financial institution via a payment gateway to have the charge validated and upon receipt of a validation result, automatically generating the invoice.

5. The method of claim 3, further comprising automatically transmitting the invoice to the customer.

6. The method of claim 3, wherein the profile data of each customer of the service provider comprises the customer's service plan, the charge calculating step comprising assessing a base charge amount according to an amount of data storage space used in the time interval, determining a service plan level that the customer belongs to, and modifying the base charge according to one or more of: any discounts or promotions to be applied commensurate with the service plan level.

7. The method of claim 3, wherein the profile data of each customer of the service provider and metadata representing that customer's use of services are stored in a first database associated with the service provider, the storing of the profile data and metadata comprising:
importing the customer profile and metadata to a second database adapted to accept queries in conjunction with the performance of the particular administrative task.

8. The method of claim 3, wherein the metadata in the first database is appended to a second database to form a complete and centralized database for customer data.

9. The method of claim 8, further comprising the step of synchronizing the first database with the second database to update the second database.

10. The method of claim 1, further comprising providing an interface that enables a user to initiate performance of a particular administrative task.

11. The method of claim 10, wherein via the interface, the user initiates functionality adapted. to perform customer management functions such as querying specific information about the customer and the customer's accounts with the service provider.

12. The method of claim 10, wherein via the interface, the user initiates functionality adapted to perform customer billing management functions including one or more of: determining of service level plans, determining customers to be charged, determining processed invoices, check billing function; scheduling automatic performance of a particular business function.

13. The method of claim 10, wherein via the interface, the user initiates functionality adapted to perform partner management functions including one or more of: adding new partner associated with the service provider including corresponding contact information; adding agents associated with new or existing partners listing; and tracking payments to the partners.

14. The method of claim 13, wherein via the interface, the user initiates functionality adapted to perform agent management functions including one or more of: tracking relationship of an agent to the service provider, and tracking payments to agents of the partners.

15. The method of claim 10, wherein via the interface, the user initiates functionality adapted to perform independent affiliate management functions including: tracking relationship of an affiliate to the service provider; and tracking payments to affiliates.

16. The method of claim 10, wherein the interface is provided via a web browser device.

17. The method of claim 10, wherein the interface is provided on a client device in communication with a server.

18. A networked based system for automating performance of administrative tasks for businesses that provide remote data back-up services for customers, the system comprising:
a means for storing information including profile data of each customer of the service provider and information including customer account metadata representing each customer's use of data storage space associated with back-up services performed by the service provider;
a client device providing an interface for a user to generate at least one query to initiate performance of a particular administrative task; and
server means responsive to the at least one query for automatically retrieving customer profile data and customer account metadata from the storing means and processing the data and metadata in conjunction with the particular administrative task.

19. The system of claim 18, wherein the metadata comprises an amount of data space in a storage device utilized by the service provider in backing up data for a particular customer.

20. The system of claim 19, wherein the particular administrative task comprises automated billing transaction, the server means comprising:
means for calculating a charge commensurate with an amount of data backed-up by the service provider in a predetermined time interval for a particular customer; and
means for automatically generating an invoice including the charge.

21. The system of claim 20, further comprising a payment gateway means for transmitting the calculated charge to a financial institution to have the calculated charge validated, and upon receipt of a validation result, automatically generating the invoice.

22. The system of claim 20, wherein the profile data of each customer of the service provider includes a customer's service plan, the means for calculating a charge comprising: means for assessing a base charge amount according to an amount of data storage space used in the time interval, means for determining a service plan level the customer belongs to, and means for modifying the base charge according to one or more of: any discounts or promotions to be applied commensurate with the service plan level.

23. The system of claim 20, further comprising: means for automatically transmitting the invoice to the customer.

24. The system of claim 20, wherein the means for storing information comprises: a first database associated with the service provider, and a second database adapted to accept queries in conjunction with the performance of the particular administrative task, the system further comprising:
means for importing the customer profile and metadata information from the first database to the second database.

25. The system of claim 24, further comprising means for appending the metadata in the first database to the second database to form a complete and centralized database for customer data.

26. The system of claim 24, further comprising:
means for synchronizing the first database with the second database to update the second database.

27. The system of claim 18, further comprising: means for communicating the at least one query from the client device to the server means over a network connection.

28. The system of claim 27, wherein the at least one query is communicated to the server means over an Internet connection, the client device comprising a web-browser providing the interface.

29. The system of claim 27, wherein the means for communicating comprises a TCP/IP based communications protocol.

30. The system of claim 18, wherein the server means comprises means for scheduling automatic performance of a particular business function.

31. The system of claim 18, wherein the server means comprises automated report generating means for extracting the customer profile and account metadata and generating reports at various levels of detail.

32. A web-based system for performing business management functions for a provider of remote data back-up services, the system comprising:
a client device providing an interface for a web user enabling generation of at least one query to initiate performance of a particular business function regarding a customer's account with the service provider;
a data storage device for storing information including profile data of each customer of the service provider and information including account metadata representing that customer's use of storage space associated with back-up services performed by the service provider;
a first server means for receiving the generated at least one query over an Internet connection, and enabling secure communication of the at least one query to a second server means; and
the second server means adapted for accessing customer profile data and account metadata from the data storage device and processing the data in conjunction with a requested business management function, and securely downloading the requested data to the client device via the Internet connection.
